(19) United States
(12) Patent Application Publication
(10) Pub. No.: US 2017/0039784 A1
(43) Pub. Date: Feb. 9, 2017

(54) AUTOMOBILE DIAGNOSTIC DEVICE USING DYNAMIC TELEMATIC DATA PARSING

(71) Applicants: Jeremy Z. Gelbart, Boca Raton, FL (US); Steven J. Wolf, North Miami Beach, FL (US)

(72) Inventors: Jeremy Z. Gelbart, Boca Raton, FL (US); Steven J. Wolf, North Miami Beach, FL (US)

(73) Assignee: Autobrain LLC, Boca Raton, FL (US)

(21) Appl. No.: 15/265,437

(22) Filed: Sep. 14, 2016

Related U.S. Application Data
(63) Continuation-in-part of application No. PCT/US2015/021463, filed on Mar. 19, 2015.
Application No. PCT/US2015/021463 is a continuation-in-part of application No. 13/923,797, filed on Jun. 21, 2013.
(60) Provisional application No. 61/955,469, filed on Mar. 19, 2014.
(60) Provisional application No. 62/107,091, filed on Jan. 23, 2015.
(60) Provisional application No. 62/108,335, filed on Jan. 27, 2015.
(60) Provisional application No. 61/662,459, filed on Jun. 21, 2012.

(51) Int. Cl. G07C 5/00; G07C 5/08

(52) U.S. Cl. CPC G07C 5/008; G07C 5/0808; G07C 5/0825; G07C 2205/02

(57) ABSTRACT

An on-board vehicle diagnostic device in communication with a vehicle is provided. The device includes a housing formed from a suitable material. The housing includes a plurality of connector pins. The pins are formed to interconnect with an OBD port, such as any OBD-II port found in a vehicle. The pins are additionally formed such that they engage the OBD-II port and remain connected to the port. The OBD-II port is located in the vehicle, and is in communication with an on-board vehicle processor. Also provided within the housing are a wireless transmitter and a wireless receiver. The wireless receiver may be configured to receive, from the on-board vehicle processor, vehicle diagnostic pin-readouts. The pin-readouts may include location information, such as GPS coordinates. The wireless receiver may be further configured to receive geofence coordinate information, which may correspond to a geographical area.

### CROSS-REFERENCE TO RELATED APPLICATIONS

This application is a continuation-in-part of PCT Application Number PCT/U.S. 2015/021463, filed in the United States Patent and Trademark Receiving Office on Mar. 19, 2015, which claims the benefit of provisional application number 61/955,469, filed in the United States Patent and Trademark Office on Mar. 19, 2014 and titled “Automobile Services System and Software,” provisional application number 62/107,091, filed in the United States Patent and Trademark Office on Jan. 23, 2015 and titled “Automobile Services System and Software,” and provisional application number 62/108,335, filed in the United States Patent and Trademark Office on Jan. 27, 2015 and titled “Systems for determining a location of an optimal fueling station.” This application is also a continuation-in-part of U.S. application Ser. No. 13/923,797, filed in the United States Patent and Trademark Office on Jun. 21, 2013, which claims the benefit of provisional application number 61/662,459, filed in the United States Patent and Trademark Office on Jun. 21, 2012 and titled “Method for drivers of motor vehicles or motor boats to lock in the price they pay for fuel irrespective of the quantity of fuel they use in the future.” The entire disclosures of the applications PCT/U.S. 2015/021463, U.S. 61/955,469, U.S. 62/107,091, U.S. 62/108,335, U.S. 13/923,797, and U.S. 61/662,459, identified above, are incorporated herein by reference in their entireties.

### BACKGROUND

The present invention relates to a diagnostic controller, or an onboard diagnostic (OBD) device for automobiles.

Generally, use of the OBD device has been restricted to mechanics or other individuals or companies that provide automobile services. However, vehicles include a built-in computer, allowing for user's to potentially monitor data about the vehicle's performance, as well as the state of the vehicle.

Provided, therefore, is a vehicle apparatus in serial communication with a vehicle for forming an electronic connection with an on-board vehicle processor. The connection is formed via OBD-II compliant pins. The pins receive diagnostic pin-readouts transmitted from an on-board controller of the vehicle.

### SUMMARY OF THE INVENTION

An on-board vehicle diagnostic device in communication with a vehicle is provided. The device includes a housing formed from a suitable material. The housing includes a plurality of connector pins. The pins are formed to interconnect with an OBD port, such as any OBD-II port found in a vehicle. The pins are additionally formed such that they engage the OBD-II port and remain connected to the port.

The OBD-II port is located in the vehicle, and is in communication with an on-board vehicle processor. Also provided within the housing are a wireless transmitter and a wireless receiver. The wireless receiver may be configured to receive, from the on-board vehicle processor, vehicle diagnostic pin-readouts. The pin-readouts may include location information, such as GPS coordinates. The wireless receiver may be further configured to receive geofence coordinate information, which may correspond to a geographical area.

The present disclosure further provides a processor coupled to the connector and the wireless receiver. The processor may be configured to determine a plurality of vehicle location coordinates from the GPS, determine whether a plurality of the location coordinates are located outside the geofence; and initiate a device activation sequence. Upon initiation of the device activation sequence, the apparatus may transmit an operational input data packet transmission to a second processing device.

The above and other objects, features and advantages of the present invention will become apparent from the following description read in conjunction with the accompanying drawings, in which like reference numerals designate the same elements. The present invention is considered to include all functional combinations of the above described features and corresponding descriptions contained herein, and all combinations of further features described herein, and is not limited to the particular structural embodiments shown in the figures as examples. The scope and spirit of the present invention is considered to include modifications as may be made by those skilled in the art having the benefit of the present disclosure which substitute, for elements presented in the claims, devices or structures upon which the claim language reads or which are equivalent thereto, and which produce substantially the same results associated with those corresponding examples identified in this disclosure for purposes of the operation of this invention. Additionally, the scope and spirit of the present invention is intended to be defined by the scope of the claim language itself and equivalents thereto without incorporation of structural or functional limitations discussed in the specification which are not referred to in the claim language itself.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 depicts an illustrative computer system and network in accordance with the principles of the invention;

FIGS. 2A-2E show an illustrative apparatus in accordance with the principles of the invention;

FIG. 3A, 3B, 4A and 4B show illustrative processes in accordance with the principles of the invention; and

FIGS. 5-12 show illustrative information in accordance with the principles of the invention.

### DETAILED DESCRIPTION OF THE INVENTION

An on-board vehicle diagnostic device (“diagnostic device” or “device”) is provided. The diagnostic device forms an electronic connection with an electronic port within a vehicle, such as an OBD port.

The OBD port (also commonly referred to as the OBD connector) includes a plurality of female connectors. In an exemplary embodiment, a 16-pin connector, arranged in a 2×8 format, is provided.

The device includes corresponding male pins for insertion into the connector, such as a series of 16 pins that engage the female pin receivers. A female pin receiver may also be included in the device, to receive power transmission from the vehicle, via the OBD port, for powering the device. The pins of the device are formed such that they releasably engage the OBD port. Additionally, a groove may be provided in the pins, in order to form a secure connection between the male and female pin components.

The device includes a housing formed from a suitable material. At a first end of the housing is the connector, including the pins. Within the housing, a wireless transmitter is provided, which

The present invention includes providing a full suite of vehicle-related services by communicating vehicle-related information to users. The present invention includes a device that plugs into the On-Board Diagnostics (“OBD”)-II port of any car sold after 1996 that will be used to deliver a full suite of vehicle-related services. The device reads information from a vehicle's computer. The device may also include an Accelerometer, GPS, Wireless communication (e.g., GSM or CDMA), Near Field Communication (e.g., Bluetooth), WiFi or gyroscope.

On-Board diagnostics is an automotive term referring to a vehicle's self-diagnostic and reporting capability. OBD systems provide the vehicle owner or repair technician access to the status of the various vehicle systems and sub-systems. Currently, the OBD is not being utilized to its fullest extent.

As can be seen, there is a need for a system and software that uses the OBD for additional functions.

For the sake of illustration, the invention may be described as part of a system. The OBD device may be described as being part of the system. The system may include one or more of the features of the apparatus that are shown or described herein. The system may include one or more OBD devices (hereinafter referred to as “OBD device” or the “device”), one or more servers, and one or more computing devices, such as a mobile device or computer. It should be noted that the system is not limited to these devices, and may include additional devices as well.

Embodiments of the present invention may include the device in combination with specialized processes implemented in accordance with the device. For example, a user can trigger a set of functions to monitor information from the device and issue alerts to the user if certain thresholds are exceeded or reached. This can be accomplished with one click or toggle. The selection of one or more operating modes with one click establishes, for example, a pre-determined set of thresholds and provides alerts for any thresholds that are exceeded or reached or reached.

In one embodiment, the invention may include a device. The device may be an OBD device. The OBD device may adhere to, and include software and hardware that adhere to, the OBD-II standard. Specifications of the OBD-II standard, implemented by the EPA, are incorporated herein by reference in their entirety. The OBD device in accordance with the invention need not include functionality limited to these standards.

The device may include a connection, and may be releasably connected to a vehicle. The device may be connected to the vehicle via the data port. The connection may be a plug-in connection, USB port connection, serial port connection, pin connection, or any other suitable connection. The connection may also be wireless using protocols such as WiFi or Bluetooth.

The device may interact or communicate with a computer. The computer may be an on-board computer located within the vehicle (also referred to as the “vehicle computer”). The vehicle computer may be configured to measure one or more data points or parameters from the vehicle.

It should be noted that the invention is contemplated with the OBD device as separate device that plugs into, or otherwise connects with the vehicle, as well as with the OBD device being built into the vehicle. Thus, some or all of the features of the OBD device may be connected to the vehicle computer, integral to the vehicle, or may be built into the vehicle computer itself

The OBD device may be any suitable diagnostic device for use in a vehicle. The device may be a measurement device. The invention is operable with a standard OBD device, as well as with an OBD device including the unique features discussed in this application.

The OBD device may include one or more processors, transmitters, receivers, transceivers and any additional suitable components.

The OBD device may include one or more communication systems configured to operate over various communication protocols. The OBD device may be configured to operate using a GSM or GPRS network. The OBD device may be configured to operate using 2G, 3G, 4G, LTE or any other suitable connectivity technology. The OBD device may include one or more cellular or GPS antennas. The OBD device may include short-range wireless communication hardware, such as Bluetooth and Wi-Fi chipsets.

The OBD device may include an internal battery supply. The OBD device may draw power from external sources, such as solar power, or via connectivity to a car port. The OBD device may be configured to draw power from multiple sources.

The OBD device may be configured to support TCP, UDP and FTP protocols. The OBD device may include SMS connectivity, and may be configured to receive and send SMS messages. The OBD device may be configured and updated via any suitable communication protocols, such as those already described.

The OBD device may include firmware. The firmware may be configured to operate using predetermined communication protocols. Thus, the device may be configured to receive one or more commands. The commands may be altered to vary the information collected, received and/or transmitted by the device. For example, the OBD device may receive, via the connection port with the vehicle computer, a command or instruction to collect information related to the speed of the vehicle. In another example, the OBD device may be instructed to collect data related to the acceleration and location of the vehicle, and to transmit the information at predetermined intervals.

The OBD device data usage may be optimized to limit the quantity of data sent and received by the device. Therefore, in accordance with the invention, the OBD device may be instructed to transmit information to the server only in response to a specified occurrence or event. For example, the OBD device may normally receive continuous data reports from the vehicle computer.

The OBD device may limit battery usage by incorporating a low-powered processor within the housing. Thus, the lowered processor may draw less power from the battery supply. Additionally, the OBD device may limit data usage by transmitting data using batch transmission or reporting.

In accordance with the invention, the OBD device/controller is specifically configured to provide a solution to a problem within the field of electronic data transmission over mobile devices. That is, the device/controller hardware is customized to address the issue of excess data transmission. Thus, the OBD device/controller provides a specified solution to reduce the increased cost associated with transmitting large amounts of data, as well as to address the problem of increased battery and bandwidth usage resulting from the requirement for transmitting large amounts of data, and providing the solution to the problem of transmitting data where there is not sufficient wireless reception for transmitting the required data. In accordance with this solution, in one embodiment, the location of the vehicle is transmitted to a user only in response to receiving a request from the user for the specific location of the vehicle. Thus, the OBD transmitter is specifically configured to only transmit a location when instructed to do so, as opposed to consistently transmitting a location signal.

In order to keep data usage down, event based reporting may be used. Rather than have the device send all information to the server at particular interval (i.e., 30 seconds), use of events allows the device to automatically notify the server when the event occurds. For example, to know the precise route that a driver took, GPS coordinates may not be used every 10 seconds. Instead, reports may be provided every time the vehicle changes heading, which will reduce the amount of data sent. It should be noted that event-based reporting may be used in conjunction with normal data transmission.

The system may include a server, such as the server already described. The server may include one or more processors, transmitters, receivers, transceivers, and any additional suitable components. The OBD device may be in contact with the server. The server may set controls for the OBD device. The OBD device may be instructed by the server to only send an alert to the server when the data received and/or processed by the OBD device indicates that a threshold has been exceeded or reached (i.e., speed threshold), a limit has been violated (i.e., geofence) or an event has occurred (movement detected in the vehicle by an onboard OBD gyroscope or accelerometer). In another example, the OBD may be instructed to send an alert only when multiple events have occurred, such as both the speed threshold limit has been exceeded or reached and the geofence has been breached/violated.

Additional examples of data usage optimization of the OBD device may include instructing the OBD to only transmit a message that a threshold has been violated, and the type of threshold that has been violated, or transmitting a message containing additional data such as the particular data of the threshold violation, such as location, duration, etc.

The OBD device data may be transmitted from the OBD device to a server or plurality of servers and/or computers over cellular networks, wireless networks, USB, infrared, NFC or any other suitable transmission protocols. The OBD device may transmit data to the servers using any other suitable protocols, such as UDP, UDP-C, TCP/IP, TU and SMS.

Vehicle data retrieved from the vehicle computer by the OBD device may be processed at one or more locations. Various configurations as to where and how to process the vehicle data may be selected, programmed or input by a user, or by the company or entity responsible for managing the OBD device and its service.

In one embodiment, a user may program, or transmit an instruction to, the OBD device to process the data using the OBD device's processor. The user may transmit, using a telephone, mobile device, smartphone, computing device, such as a mobile device, laptop, desktop or server, application, or any other suitable program or device, a series of instructions to the OBD device on how to process data received from the vehicle computer. For example, the OBD may be instructed to only send speed information of the vehicle when the vehicle exceeds a programmed speed threshold, such as 50 MPH. In another example, the OBD device may be instructed to monitor vehicle computer data to determine if a driver in the vehicle has engaged the hard brake.

In another embodiment, the OBD device may be programmed, via firmware, software, initial instructions, updated instructions, or in any suitable way, to transmit certain information to the server. The instructions may include an instruction for the OBD device not to process the data, and to send the data to the OBD device to be processed.

For example, the device may receive an instruction to transmit all acceleration data to the server. The device may further receive an instruction to transmit the acceleration data (or any other suitable data) at predetermined intervals. That is, the OBD may be instructed to transmit all deceleration data to the server at 30-second intervals. The OBD may be further customized to transmit all data related to a particular parameter, such as deceleration data, while only transmitting predetermined/preset threshold violations for another parameter, such as transmitting speed data only when the speed threshold is violated. For example, deceleration data (or any other parameter that may be processed by the OBD) may be transmitted at a periodic rate of 60 Hz, 30 Hz, 20 Hz, 5 Hz, 2 Hz irrespective of whether there is a change in the deceleration parameter. The deceleration data may also be transmitted only upon a change in such parameter. The deceleration data may also be transmitted at the next scheduled transmission time only if there is a change. That is, if parameters in general or a particular parameter, may be transmitted at 30 Hz, and there is a change in a parameter between possible transmissions, the transmissions would not take place immediately after a change in the parameter, but would only be transmitted at the next scheduled transmission.

The OBD device may transmit unprocessed or processed data to the server. The server may initially instruct the OBD device which parameters to monitor, what data to send, and at what intervals to send the data. The server may process data received from the OBD. The server may determine whether a threshold for a parameter has been exceeded or reached. The server may instruct the OBD to determine, using the OBD processor, whether a threshold for a parameter has been exceeded or reached (or fall below a threshold). If the OBD processor determines that a threshold for a parameter has been exceeded or reached, the OBD may be further instructed, either previously or at that point, to send a message to the server of the exceeding of the threshold.

In accordance with an embodiment of the present invention, the OBD device may be initialized. The initialization of the device may be performed prior to the first use of the OBD by a user.

An exemplary initialization device sequence may include (1) Input OBD device phone number (and/or other identifying OBD information such as IMEI, IP address, and the like) into server; (2) Send Initial Command to Device via, for example, SMS; and (3) Set Port, IP address, Username, Password, APN, SMS number, Communication Protocol of the device with which the OBD is to communicate.

At step 1, the OBD device may be assigned a unique telephone number. The telephone number may allow the OBD device to communicate using standard telephonic features, such as using voice calls, SMS or MIMS messaging, or transmitting or receiving data, using any suitable communication protocols.

The device phone number associated with the OBD may be saved and associated with the program server. The program server may be one device, or a series of interconnected devices or servers, that manages the OBD devices in multiple vehicles.

At step 2, the server may transmit an initial command. The initial command may be transmitted to the OBD device. The OBD device may receive an SMS from the server. The initial command notifies the OBD device of the server's IP address and Port, so that the OBD devuce may communicate with the server. The initial command may also notify the OBD device of a username and/or password to the server such that the OBD device may logon to the server. The password may be optionally required. The user may access a Graphical User Interface (“GUI”) that displays or utilizes information received from the OBD device. The GUI may be located on a user device, such as a telephone or computing device. The user device may be in contact with the server and/or the OBD device, and any other suitable devices.

At step 3, the server may set the Port, IP address, username, password, APN, SMS number and/or communication protocol for communicating with the device. In accordance with the invention, the OBD device may be plugged into a portal. The portal may be used to initially communicate initial information to the OBD device, communicate with the device, and set the information as outlined in steps 1-3. The portal may be a docking station, and the docking station may include a powering unit to charge the OBD device. The docking station may be powered using any suitable powering system.

The OBD device may receive a Subscriber Identity Model (“SIM”) card. The SIM card may be programmed via the docking station, which may send a command to the OBD device.

After the initial sequence, the OBD device may be programmed by the server. The subsequent programming sequence may include (1) receiving a response from the OBD device to the initial command; (2) sending a command to the device to query device firmware and model; (3) updating the OBD device table with model type; (4) set up thresholds, such as speed threshold, acceleration and deceleration thresholds, and geofence thresholds; (5) set the device status to ‘onboarded’ (i.e., that communication has been established with the server); (6) notify the owner of the device that the device is ‘onboarded’; and (7) send a command to the OBD device to retrieve GPS coordinates for the vehicle.

At step 1 of the programming sequence, the OBD may indicate to the server that the initial command has been received. The OBD device may validate the commands. At step 2, the query may commence a test sequence. At step 3, the device table may include a lookup table or any other suitable table stored in memory, may initialize such table and may store initial values in such table. The table may be associated with the OBD device. Each OBD device may be associated with a unique lookup table. The lookup table may be located in the server. Each device may be stored with a model type associated with it.

At step 4, the thresholds may be setup using default parameters. The default parameters may include default thresholds based on one or more modes. The default parameters may be modified. The thresholds may also be customized thresholds, input by the user. The user may input the thresholds via an application on a smartphone or computer associated with, and in direct or indirect communication with, the OBD device. At step 5, the OBD device status may be set to onboarded, which can indicate that the device is running properly. At step 6, the user may receive a notification via any suitable method that the device is onboarded. At step 7, the server may send an instruction to the OBD to determine GPS coordinates of the vehicle, using the OBD internal GPS antenna, the GPS antenna of the vehicle, or any other suitable method.

The OBD device may include a memory module, power supply, microprocessor, firmware, and one or more communication hardware chips (e.g., a Cat10 LTE Modem, Intel's 7360 LTE modem, or Qualcomm's MDM9625 LTE Modem). The OBD may be preprogrammed with data collection instructions, or may receive updated, revised, or customized instructions at predetermined or customized intervals. The OBD may be connected to the OBD port in the vehicle using any suitable connection, such as a pin connection.

The OBD device may be programmed with data collection parameters. The programming may be performed via firmware by connection to a PC or a docking port, with programming software for module firmware. The OBD may then be plugged into a pin connection or USB connection with the OBD II port of the vehicle.

The OBD may be configured to be operable with various modes. The modes may operate sequentially, or multiple modes may be utilized by the OBD at the same time.

In a first embodiment, the OBD may be utilized for vehicle pick up or drop off. In certain instances, a vehicle owner or operator (hereinafter, “owner,” but used to reference operator non-owners as well) may desire to leave their vehicle under the care of another individual or company for a temporary period of time. However, the vehicle owner may desire to monitor the vehicle, or prevent the occurrence of certain events.

The owner may initiate a mode, known herein as valet mode, to monitor the vehicle when under the care and/or custody of another person or entity. It should be noted that valet mode is merely a reference name, and is not intended to limit the scope of the invention.

The owner may input a number of parameters to be monitored. The parameters may have been input by the owner prior to leaving the vehicle with a parking attendant. The parameters may be input at the time of the handoff event to leave the vehicle to, for example, the valet or another party. The parameters may be default parameters input by the manager of the OBD system, or default parameters input by the owner.

The parameters may include a maximum speed threshold, maximum acceleration threshold, geofence coordinates, and/or odometer thresholds. The geofence coordinates may include a radius of permissible locations for the vehicle while valet mode is enabled. For example, once valet mode is activated a geofence including points on the circumference of a circle of a particular radius around the point at which valet mode was activated. That radius, may be for example, 1 mile, 0.5 miles, 1 km, 0.5 km, and the like. The radius may also be larger or smaller depending on the nature of the valet. For example, if the valet has a parking lot within a certain radius of the dropoff location, the radius may be smaller and closely surround the parking lot. The geofence coordinates may also, or alternatively, include a radius of impermissible locations for the vehicle while valet mode is enabled. The geofence coordinates may also include certain areas, such as a specified street, where the vehicle is not allowed, even when within an otherwise permissible geofence area. The prohibited areas may include, for example, areas with a level of crime higher a certain threshold or crimes related to vehicles (e.g., carjacking, vehicle theft, and the like). For example, the server and/or the OBD device may determine whether any part of the geofenced area includes areas with crime rates higher than 20% (or another percentage) more than other portions of the geofenced area (or the national average, city average, state average, or other threshold) and may then exclude that area from the geofenced area. Variables such as number of car accidents, demographic information including census data, may also be used separately or in conjunction with with crime rates

Either at the point where the owner is about to handoff the vehicle, prior to handing off the vehicle, or after the vehicle is handed off, the owner may initiate the valet mode. The valet mode may be initiated by toggling a switch or pressing a button, such as one on a smartphone application, to initiate the valet mode.

Once the valet mode is initiated, the OBD monitors the vehicle for violation of one or more thresholds. In the event a threshold violation is detected, the OBD may transmit a message to the server with data including one or more of the type of threshold violation (i.e. geofence violation), duration of violation, frequency of violation, current location of the vehicle, and any other suitable information. The server may then transmit an alert to the owner if there is a violation.

The owner may receive an alert from the user with information about the threshold violation. The owner may instruct the server to transmit threshold violation alerts at each occurrence, in real-time. Alternatively, the owner may instruct the server to transmit threshold violation alerts in batches, such as when there are a certain number of alerts (i.e. 5 alerts), or in batches at predetermined time intervals (e.g., every hour, minute, and the like).

The OBD device may additionally be operable to provide a system for facilitating retrieval of a valeted or parked vehicle. The retrieval steps may include (1) a customer instruction to retrieve the vehicle; (2) identification of the valet company or parking company responsible for the vehicle, which is determined by prior input by the user or valet company, or by determining the GPS location of the vehicle.

The OBD device may be operable to provide a system for facilitating the drop off of a vehicle to be parked. The steps may include (1) leaving the vehicle at a location; (2) initiating an application to request pickup at a specified location; (3) searching or identifying a valet or parking company to park the vehicle; (4) transferring the possession of the vehicle; (5) optionally initiating valet mode; and (5) optionally alerting the user that the vehicle has been parked.

The OBD device may be used to facilitate user pickup of a parked vehicle. In accordance with the principles of embodiments of the invention, a system may facilitate the process for retrieving a valeted vehicle using the following steps: (a) initiating a vehicle retrieval application and/or feature within an application, such as one on a phone or computer; (b) requesting retrieval of the vehicle and preparation of the vehicle for pickup; (c) identifying the valet company/valet attendant where the vehicle is parked; and (d) transmitting a message to the company/attendant to prepare the vehicle for pickup.

At step (a) above, an application may include functionality to interface with an OBD device. Thus, the application may be configured to retrieve the GPS of the vehicle using the GPS receiver located within the OBD device or within the vehicle itself (which would be provided to the application via the OBD). The application may also have previously stored the GPS coordinates of the vehicle when in the vehicle, such as when the owner drops off the vehicle at the parking facility. Further, the owner can manually enter the parking area or facility address and location within the application. The owner can also input the name of the parking facility or nearby businesses/sites and select the name on the business and/or a point on a map.

The application may be configured to harness communication systems of a telephone or computer to transmit a message. Thus, at step (b), the application may receive an input from a user to retrieve the vehicle. The application may then determine the location of the vehicle, and initiate step (c). At step (c), the application may determine the valet company associated with the parked vehicle. For example, using GPS coordinates of the parked vehicle, the application may utilize a database to determine what entity owns or operates the parking facility at that location. In another example, the application may access, via public records or mapping software, the owner of the facility. The application may also determine the contact information of the operator of the location, and at step (d), contact the parking facility.

The contact at step (d) may include phone call, a text message or an email, which includes pre-programmed details of the vehicle, and/or a vehicle ID/parking ticket.

At this point, the application may remotely activate the OBD device. Alternatively, the OBD device may be instructed to begin actively tracking the location of the vehicle, as well as when the ignition is activated. This feature allows the owner of the to determine the estimated time at which the vehicle will be ready for pickup. For example, once the OBD device determines that the ignition has been activated, the OBD device may transmit a message to the server, which then transmits an alert to the owner. The owner may then know that the vehicle will be ready for pickup in a few minutes. The server and/or the OBD may estimate the amount of time necessary to drive the vehicle from its current location to the pickup location and notify the user of such time. Even prior to the ignition being turned on, the server may use data as to how long it generally takes a particular valet company to turn the ignition on from the time a car is requested and provide a time estimate based on such data.

A sequence for tracking the vehicle using the OBD device may include: (1) the driver of a vehicle transfers their vehicle to a valet/parking attendant; (2) when the vehicle is transferred, the driver activates a vehicle monitoring mode using an application, in order to monitor the location, speed and various additional attributes of the vehicle (It should be noted that these attributes can be monitored, remotely, via the application, in real time. This allows a driver to notice, and optionally receive an alert, if the vehicle has moved outside of a geofence or is exceeding a certain speed (or other parameters/variables, for example.); (3) when the vehicle monitoring mode is initiated, a server receives initiation of the mode; (4) the server queries the OBD device for the current location of the device/vehicle; (5) the server receives the location of the vehicle; (6) the server creates a geofence with a radius around the current location and/or planned location (e.g., the location of the valet parking lot) of the vehicle; (7) the server converts the radius of the geofence into a plurality of GPS coordinates, and populates and connects those coordinates on a map within the application; (8) the server creates a speed threshold for the vehicle (the speed threshold may be based on, for example, the speed limit on particular roads); (9) the server creates acceleration and/or deceleration thresholds for the vehicle; (10) the server instructs the OBD to transmit an alert to transmit a message to the server if one or more of thresholds are violated; and (11) upon receiving a message from the server that a threshold has been violated, the user receives an alert, either as a popup within the application, an SMS message, or any other suitable format, that a threshold has been violated.

At step 6, it should be noted that the creation of the geofence may be performed using prepopulated parameters for the geofence. For example, the OBD device may be preprogrammed with a 1 mile radius. The preprogramming may be done at the device level, or at the server level. In another example, a user may input a customized geofence radius. At step 9, the speed threshold may be predetermined, or customized by the driver.

An exemplary conversion of a radius into geofence coordinates is provided, and may include the following steps: (1) determine if inradius or radius is being used (inradius =radius/(Math.cos(Math::PI/n)). This determination to use inradius may be made if it desirable for a user to stay within the radius. For a radius that a user should stay out of (i.e., a restricted area), the radius (e.g., out-radius) may be used; (2) calculate the coordinates of the polygon points. A default may be set for the number of polygon points, such as six points, or any other suitable number, with each point being 360 degrees/number of points apart. In an exemplary embodiment, with six points, point one is at 60 degress, point two is at 120 degrees, etc.; (3) for each point, the coordinates are calculated by [r*cos(degrees), r*sin(degrees)], with “r” standing for radius or inradius, which gives the coordinates in miles; and (4) the coordinates are then converted to latitude and longitude coordinates.

Exemplary formulas and code for converting the radius into geofence coordinates may include:

```
ONE_MILE_IN_METERS = 1609.344
  RADIUS_OF_EARTH_IN_MILES = 6378137
  # the distance of one degree longitude is different depending on
the latitude.
  # one degree longitude is longest at the equator and shortest at
the poles. Latitude is also variable.
  def self.convert_long_lat_to_distance lt
raise “lt cannot be nil” if lt.blank?
rlatitude = (lt / 180.0) * Math::PI
one_latitude_in_meter = 111132.954 − 559.822 * Math.cos(2 *
rlatitude) + 1.175 * Math.cos(4 * rlatitude)
one_longitude_in_meter = Math::PI *
RADIUS_OF_EARTH_IN_MILES *
Math.cos(rlatitude)/(180.0*Math.sqrt((1.0−
0.00669437999014*(Math.sin(rlatitude)**2))))
one_latitude_in_miles = one_latitude_in_meter /
ONE_MILE_IN_METERS
    one_longitude_in_miles = one_longitude_in_meter /
ONE_MILE_IN_METERS
end
Then, convert the the coordinates using the
one_latitude_in_miles and one_longitude_in_miles values as
follows:
      latitude = latitude_coordinate / one_latitude_in_miles +
latitude of midpoint
      longitude = longitude_coordinate / one_longitude_in _miles
+ longitude of midpoint
      Done.
```

The following detailed description is of several modes of carrying out embodiments of the invention. The description is not to be taken in a limiting sense, but is made merely for the purpose of illustrating the general principles of the invention, since the scope of the invention is best defined by the appended claims.

Broadly, an embodiment of the present invention provides a system for providing vehicle related services comprising: an On Board Diagnostic device (OBD) comprising wireless communication, wherein the on board diagnostic device is connected with an automobile's computer; a program product comprising machine-readable program code for causing, when executed, the device to perform the following process steps: compiling data from the automobile's computer regarding measurements of the automobile; comparing the data to threshold measurements; alerting a user of when the data sent from the automobile's computer exceeds the threshold measurements. It should be noted that the OBD device may continuously monitor the vehicle computer data.

Data points (or parameters/variables) measured by the vehicle computer may include, but are not limited to: fuel level, engine coolant temperature, battery level, fuel pressure, engine RPM, vehicle speed, intake air temperature, oxygen sensor information, barometric pressure, throttle position information, ambient air temperature, fuel type or air flow information, or any other suitable information. It should be noted that the OBD-II standard is used to govern which OBD parameters are to be monitored by the vehicle computer, and all OBD Parameter ID's are contemplated in this invention.

The OBD device may include a receiver. The receiver may receive information. The information may be received from a server. The OBD device may receive information from the computer, such as data measured or monitored by the vehicle computer. The OBD device may also receive information and/or instructions from the server. The server may be located in a separate location from the device.

The server may transmit information and/or instructions to the device. The information/instructions may include one or more variables, parameters and/or thresholds.

In accordance with the present invention, a user of the invention may monitor the state of repair of a vehicle, its location, speed, acceleration, deceleration and other vehicle-related information, using the OBD device. The OBD device may be plugged into the vehicle, and may contain software, a GPS antenna, an accelerometer, a cellular antenna to communicate data between the device and a server which could then communicate with a user. The server may communicate with the user by activation warnings and delivering information to users via a plurality of communication methods, including, but not limited to telephone calls, text messages, email, ftp, etc. The software of the present invention may allow users to use a one-click feature to set various modes, thereby allowing the user to get alerts and information about the vehicle based on parameters that can be predetermined by mode. Among other things, the present invention allows the user to easily receive and use vehicle-related information such as warnings, reports, and other information.

As mentioned above, the present invention may include an OBD device plugged into a motor vehicle. The OBD device gathers information from the vehicle's on-board computer; and independently collects information such as vehicle speed, location, acceleration, deceleration (in three dimensions) and communicates that information to server via a wireless connection, such as a cellular connection. Further, the present invention may receive requests to gather and report on specific information that the OBD device is programmed to report.

The user interface of the present invention may include a Website, Mobile App, SMS message, Phone (and other methods of communication), which allows users to select various modes using one click with each mode designed to deliver specific feedback to the users or to others. The intermediary server provides a method for communicating between the user and the OBD device. In other words, the software transmits and receives information to and from the OBD device, analyzes it and facilitates communication between the user and the website, mobile application, email, text messages or person.

A method of using the present invention may include the following; (1) Insert OBD device in vehicle port; (2) Subscribe to the OBD device monitoring service; (3) Use website, mobile application, SMS or Voice communication to initiate programming sequence and calibration of device.

Examples of modes in which the present invention may operate include:

Valet mode—A vehicle owner or driver may establish an alerts system for when a valet attendant or parking garage is mishandling the vehicle. When the driver transfers their vehicle to the valet attendant, they can initiate valet mode through an application. When the mode is activated, thresholds for, for example, speeding, acceleration, deceleration, geofence, and odometer are automatically configured. The thresholds may be preconfigured, or may be input by the user. If the thresholds are violated, the user receives an alert. For example, a speed limit of 30 mph, a circular geofence of one mile, and certain acceleration thresholds.

Family safety mode. A user may establish several safe driving thresholds. This may be established by toggling on, or selecting a one-click feature, to activate the mode. The mode may activate predetermined or preconfigured safety thresholds, including, for example, speed, hard acceleration, hard deceleration and preset geofences. When activated within the application, the application relays the activation to a server, which transmits an instruction to the OBD device to begin monitoring the vehicle computer for the threshold violations. The OBD device may be further instructed to alert the server when any of the thresholds are exceeded or reached. Once the server receives an alert that the threshold is exceeded or reached, the server may choose to send an alert to the user, based on the user's predetermined threshold configurations. Certain embodiments of the present invention may also include more than one “Profile” that may be activated and each Profile may have different pre-determined thresholds. i.e., for user A, 55 MPH and certain geofence parameters as well as certain accelerometer readings OR 65 MPH.

Towing Alerts. The user may enable monitoring of the vehicle remotely to determine if the vehicle is being towed or moved. The user may activate towing monitoring. When this mode is activated, the vehicle ignition may be off. It should be noted that towing monitoring may also be activated when the ignition is on, such as when the OBD device detects upward movement of the vehicle. The OBD device may then be instructed, via the server, to monitor the vehicle. It should be noted that in all modes, and in the towing mode, the OBD may utilize vehicle computer data, as well as data determined by the OBD device hardware and software. For towing mode, the OBD device may monitor for one or more conditions when the vehicle is ignition is off, and not switched on. The OBD device may monitor if: (a) the accelerometer and/or GPS antenna/system and/or gyroscope reports the vehicle is being tilted and/or lifted (for example, if a change in the altitude parameter in the GPS is detected, or if the accelerometer and/or gyroscope detect a change); (b) the vehicle is moving or (c) there is a sudden acceleration. The accelerometer or gyroscope may be located within the vehicle itself, or may be built into the OBD device. Thus, the OBD device may determine, when the ignition is off, that the vehicle is moving or there is an acceleration, based on data retrieved from the vehicle computer. Alternatively, the OBD device may determine that the vehicle is moving or there is an acceleration based on the accelerometer and/or gyroscope and/or GPS antenna/system within the OBD device.

The OBD device may send a message to the server that movement has been detected when the ignition is off. In an embodiment, the OBD device may send the message only when sufficient movement has been detected. Thus, the threshold for movement may include determining that the movement has occurred for a sufficient duration, such as continuous movement for more than 30 seconds (or 20 seconds, or 15 seconds, or 10 seconds, or 5 seconds, or 3 seconds, or 1 second), and/or sufficient acceleration (for example, 3 m/ŝ2 or 4 m/ŝ2).

Attendance Mode. The user may enable monitoring of a vehicle associated with the OBD device. The attendance mode, or school attendance mode, may be used to monitor work, school, medical or other repeat appointments or time commitments. Thus, whenever an individual must drive to a specified place, the attendance mode allows monitoring to ensure that the user is attending. Additionally, it provides functionality to ensure that the user is attending for the right amount of time. The attendance mode may be enabled by a first user, who may be the administrator of the device. The school attendance mode may be enabled on a per-use basis, such as every time a child uses the vehicle, the administrator enables school attendance mode. Alternatively, school attendance mode may be enabled for extended periods of time, such as weeks, months or years.

The monitoring of the vehicle by the administrator of the OBD device may allow monitoring of a student or child's vehicle. The administrator may establish permissible routes for the vehicle. The permissible routes may be established by the administrator by using a user interface. For example, the user interface may provide the administrator with a map, and the administrator may select a route (or a plurality of routes) and designate the route as permissible. The administrator may also select one or more allowable deviations, such as selecting a parallel avenue or block (in the case of traffic, for example). Alternatively, the system may include a threshold for allowable deviations, such as if traffic is detected, allowing a deviation of a block (or 2 blocks or 3 blocks or 4 blocks), or mileage radius (such as 0.5 miles or 1 mile or 1.5 miles). Traffic may be detected by receiving such traffic from a third party provider or by analysis performed by the OBD device or the server. For example, the server may receive information as to the speed and location of the vehicle. Based on the location and/or speed of the vehicle as compared to the speed limit of the road on which the car is driving and/or the speed of the vehicle on previous trips on the road as previously related by the OBD to the server or as stored in the OBD. The server may take into account the time of day in determining whether the vehicle is in traffic, warranting deviation from the permissible route. That is, while 30 MPH may be normal for 2 p.m. on a weekday, 15 MPH may be normal for 5 p.m. on a weekday. The server may have a threshold to warrant deviation such as 50% (or 25% or 75%) of the normal speed based on at least one of the following factors: location, date, time, weather, whether the day is a holiday, current driver, gender of the driver, age of the driver, and the like.

The administrator may establish permissible routes to/from the student's school, and may provide monitoring and reporting of any divergence from the permissible routes. The monitoring and reporting of divergence from the routes may include receiving information from the OBD device, which may be programmed to detect stoppage of the vehicle. Further, in one embodiment, the OBD device may analyze traffic, either from publicly available traffic resources such as news sites, smartphone traffic applications, or any other suitable traffic provider. The OBD device may then determine that, if the vehicle stops when there is no detected traffic, an impermissible stop has occurred. The OBD may also use its onboard accelerometer to determine sudden stops and delays. Thus, the device may detect stops along the way and delays of more than a predetermined amount of time (such as, for example, 1 minute, 2 minutes, 3 minutes, 4 minutes or 5 minutes). The predetermined number of minutes for stops may be preconfigured by the system, or may be input the user. The number of minutes for stops may be based on the maximum amount of time a red light may stay red and may take into account the distance the car is from the light (since it may take time for the cars in front of the relevant car to move). The OBD device may warn an administrator if the vehicle leaves the school location, or travels outside an authorized route, at unauthorized times.

Carpool Mode and School Bus Mode. A user may input, via any suitable method, such as on a website or application on a smartphone, one or more participants in a carpool or bus. The carpool may be one or more individuals sharing a vehicle. Carpool mode may monitor drop/off and pickup locations of one or more individuals within the carpool, set permissible routes and deviations for carpool, set an order of pick up/drop off for carpool participants, monitor vehicle progress along carpool route, and report any changes to a route to authorized carpool participants. The bus mode may monitor, for each user, the progress of one child on a school bus.

In one embodiment, the server may receive, from a user input into a user interface, a carpool order for pickup and/or drop off. The order for pickup may differ from the drop off order. In another embodiment, the server may determine the order for pickup and order for drop off The user may then adjust the order.

The server may transmit the order to the OBD device, and instruct the device to monitor the stopping points (e.g., drop offs and pickups) of the vehicle. The OBD device may be instructed to monitor the location of drop offs and pickups, as well as the order in which they occur. The OBD device may be further instructed to transmit a message to the server if the order and/or duration of the drop off and pickups is different than the prepopulated list. The OBD device may also transmit, using its onboard GPS antenna, the location of the vehicle to the server. The OBD device may transmit its location in real time, or at predetermined intervals, such as every 30 seconds, or 1 minute, or 2 minutes, or 3 minutes, or 4 minutes, or 5 minutes. The server may then transmit the information to one or more users, who may monitor the progress of the vehicle along the route, and receive any changes or deviations from the route. The OBD device may also calculate estimated times until each stop, and at predetermined intervals, or in real time, transmit the estimated times to the server. The server may then transmit an alert to the user.

In one embodiment, such as school bus mode, a user may transmit a query to determine the location of a child on a school bus. The location may be returned from the OBD device of the school bus. Alternatively, the location may be received from the child's cell phone. In another embodiment, the location may be crowdsourced based on the GPS location of all or some of the children's phones on the bus.

Follow mode. The system may be configured to allow multiple users to follow each other in their vehicles to a predetermined or non-predetermined location, and/or along a predetermined route or a non pre-determined route by creating a Follow Mode event. Each of the users may enable the follow mode, which transmits an instruction to the OBD device in their vehicle to transmit location signals using a GPS antenna. Once a user selects follow mode, they will be prompted to enter identifying information for one or more other users. The leader may generate a unique code that can be shared with potential followers. When the followers enter this code, they may see the location of the leader. The system will alert the other user(s) of the request for them to participate in a follow mode event, and each user may separately and proactively accept the invitation before their location is revealed to other participants. Once they accept the invitation, each user's OBD device may transmit its location using the onboard GPS antenna, or through the GPS antenna of a telephone, to the server. The server may then aggregate the locations of all participants, and display them on a map.

One of the users may designate themselves as the Leader (similar to the leader on a conference call). Once the Follow Mode invitation(s) have been accepted, all participants in the Follow Mode event can display a map showing the location of each participant in the Follow Mode event, or just the location of the Leader. The location may be determined based on the GPS coordinates received from the OBD device for each participant, or based on the GPS coordinates retrieved from a participant's phone.

If the event is for travel to a pre-determined location, the route to that location may be displayed on a Graphical User Interface (GUI) to participants, along with the location of the Leader and/or the pre-determined location, and/or along with all other participants' vehicles as waypoints on a map. If the event is not to a predetermined location, the location of the Leader and the individual user, or the location of the leader and all participants, may be displayed on a map.

Driving Safety. When this mode is activated by a user, the system monitors to determine when the ignition is on and the speed of a vehicle exceeds a pre-determined threshold. The ignition status is determined via the OBD device, which receives ignition information from the vehicle computer. The speed of the vehicle may be determined using the device accelerometer, or analysis by the OBD of the vehicle computer information (including, for example, GPS coordinates). If the ignition is active and a pre-determined threshold is exceeded or reached, functions associated with a driver's email, text messaging, and/or voice calling will be disabled and/or modified on the cellular phone of a person associated with that particular vehicle.

The OBD device is additionally operable to detect potholes. In one embodiment, the OBD contains a gyrometer and accelerometer, which detect changes in speed and movement to determine the presence of potholes. Information about the location of the potholes is compiled and sent to the server, where it is stored in a database. The pothole information is then aggregated and provided to other users.

Safe Baby Mode (“SBM”). The user may activate the mode by toggling a switch or clicking a selection. This mode may be activated for extended period of time. For example, SBM may be activated when a user brings a baby home from a hospital, and remain active for a number of years.

When active, SBM assists a user in monitoring their vehicle for children. Thus, when a user exits the vehicle, checks are performed to make sure that no baby, infant, or child is left inside the vehicle.

When the OBD device detects that the car ignition has been shut off, the OBD may send a notification to the server, which transmits an alert to a driver or the person who activated SBM. The notification may alert the driver that the vehicle has been turned off, and may be presented as a pop-up alert, either within a smartphone application or on a phone, as an email, or SMS message, and the like.

If the driver or administrator of the mode does not confirm that all children are removed from the vehicle within a predetermined period of time, such as, for example, 10 minutes, the system may activate a microphone within the OBD device in order to listen in on the vehicle. If the OBD device detects a noise level above a predetermined threshold, indicating the presence of a child, or noise for an extended period of time that is determined, by the system, to be human generated noise, the system may initiate a call to first responders. If the OBD device determines that a human may be in the vehicle, the OBD device may connect with a call center, which may allow a human operator to determine whether a baby is in the vehicle, based on sound, or video. The OBD may also determine when the the human is a child by analyzing the pitch, breathing patterns, determine the words used via voice recognition, and the like. Thus, if for example, the OBD and/or the server determines that a person is speaking (e.g., on a phone) such that the voice recognition can determine the words being used, it is determined that that person is not a baby or an infant. Once voice recognition software determined the words being used, the OBD and/or the server may use the Flesch Reading Ease scale and/or the Flesch-Kincaid Grade-Level scale to determine the age of the person speaking. Thus, for example, using the scale it may be determines that the speaker is 5 years old and, thus, a child is still in the vehicle.

In SBM, the OBD device may also include a temperature sensor. Thus, if the device determines that the temperature is beginning to rise, or rises above a predetermined acceptable threshold level, the system may contact emergency responders. In another embodiment, if the temperature falls below a certain level, the OBD device can be instructed to, and then trigger, turning on the vehicle's heating system. Likewise, if the temperature exceeds a certain predetermined level (such as, for example 90° or 100° or 110°, the OBD device may be instructed to turn on the vehicle's air conditioning system. The air conditioning or heating systems may be turned on by the OBD device.

The OBD device may further include a motion sensor, which can be used concurrently with the temperature sensor and/or microphone to detect the presence of a child, or afterward. Additional features may include a pressure sensor, such as one installed under the child seat, which is in communication (e.g., Bluetooth or WiFi) with the OBD device, and is configured to instruct the OBD device that a child is present or absent from the seat.

SBM may be operable, therefore, to prevent unintentional leaving of a child or baby in a vehicle. Toggling on the SBM mode instructs the system to begin checking for a child in the vehicle. Thus, the server receives an instruction from a user device to initiate SBM. The system is then configured to receive, when in SBM, an alert that the vehicle ignition is turned off. When the vehicle ignition is shut off, the OBD device transmits a notification of such to the server. The server then transmits an instruction to the OBD device, or alternatively, at the time when SBM is activated, the OBD device receives an instruction, to determine that a driver or individual has vacated the vehicle. The OBD may determine, once the ignition has been turned off, whether a Bluetooth connection between the vehicle and a mobile device has been terminated. Alternatively, seat sensors may be in communication with the OBD device and/or the server, and may indicate whether anyone is remaining in the vehicle.

The SBM may utilize motion sensors, video cameras, such as a video camera mounted in the vehicle or on the OBD device, infrared sensors located within the OBD device or the vehicle, a microphone to detect a child voice or sounds, or any distress sounds, and a pressure sensor in the child car seat.

If the OBD determines, from any of the sensors, that a child is in the vehicle, the notification sequence notifies the driver, as well as one or more emergency contacts input by the user and stored within the OBD and/or server. Alternatively or additionally, the system may notify emergency authorities. The notifications may occur via SMS or telephone call.

In one embodiment, emergency services may only be notified when dangerous conditions are detected within the car. Thus, even when a child is detected within the vehicle and the ignition is off, the OBD may then determine the temperature, the recent drop or rise in temperature, air quality within the vehicle, and other suitable conditions. If the conditions are all suitable, emergency services may not be notified. Instead, additional attempts may be made to contact the driver or owner. Only then may emergency services be notified, after, for example, five attempts or twenty minutes, or any other suitable number. In the event of a sudden temperature change, emergency services may be contacted immediately.

In one embodiment, some or all of the following sequence may occur, in no particular order: (1) determine the local Public Safety Answering Point (PSAP) based on the GPS coordinates of the vehicle; and (2) notify the appropriate PSAP that there is a child in the car and needs assistance. Notification of the local PSAP may occur with the OBD device communicating with the server, which then instructs the call center to call the local 911/PSAP.

The server may transmit an instruction to the OBD device to remotely control some functions within the vehicle in order to increase the baby's safety while waiting for the driver, parent, or authorities. The OBD may communicate with the vehicle's computer and instruct the computer to turn on the air conditioning or heating system, open or close windows, turn on or off lights, and lock or unlock the doors.

The present invention may also be operable to predict when the car battery will fail, project traffic based on driving patterns, monitor fuel usage and efficiency, and display the different costs/savings of adopting different driving strategies.

Exemplary threshold calculations for the various modes may be as follows, with the following speed thresholds in miles per hour, and acceleration thresholds and deceleration thresholds in miles per hour per second:

FAMILY_SAFETY_MODE_SPEEDING_THRESHOLDS = {
“defensive” => { spd_threshold: 55, rpm_threshold: 3500, acc_threshold: 5, desc_threshold: 7 },
“normal” => { spd_threshold: 65, rpm_threshold: 4500, acc_threshold: 7, desc_threshold: 9 },
“reckless” => { spd_threshold: 75, rpm_threshold: 5500, acc_threshold: 9, desc_threshold: 11 }
}
TEENAGE_SAFETY_MODE_SPEEDING_THRESHOLDOLDS = {
“defensive” => { spd_threshold: 55, rpm_threshold: 3500, acc_threshold: 6, desc_threshold: 7 },
“normal” => { spd_threshold: 65, rpm_threshold: 4500, acc_threshold: 7, desc_threshold: 9 },
“reckless” => { spd_threshold: 75, rpm_threshold: 5500, acc_threshold: 9, desc_threshold: 11 }
}
SENIOR_SAFETY_MODE_SPEEDING_THRESHOLDOLDS = {
“defensive” => { spd_threshold: 55, rpm_threshold: 3500, acc_threshold: 6, desc_threshold: 7 },
“normal” => { spd_threshold: 65, rpm_threshold: 4500, acc_threshold: 7, desc_threshold: 9 },
“reckless” => { spd_threshold: 75, rpm_threshold: 5500, acc_threshold: 9, desc_threshold: 11 }
}

Exemplary protocols are provided below:

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

A system for monitoring valet and/or parking facility usage of a vehicle is therefore provided. The system may include an apparatus or method.

The system may include a server. The server may receive information from a user. The user may transmit the information using a computer, web application, website, smartphone, application, or any other suitable device.

The user may transmit an instruction to the server to initiate a valet mode. The initiation of the valet may be selected by the user on a graphical user interface. The user may instruct the server to initiate a valet restriction function. In turn, the server may transmit a message to the OBD device for the associated vehicle to monitor the vehicle usage, via data received from the onboard vehicle computer, for violation of one or more predetermined thresholds, such as speed, acceleration, deceleration, and geofence violation.

The user may form a geofence around the location of the vehicle. Thus, the user may know that he or she desires to leave the vehicle at the parking facility for two days. The user may be concerned about “joyriding” or the use of the vehicle by one or more valet attendants. The user may therefore transmit a request to the server to form a geofence. Alternatively, the settings of valet mode may be preconfigured or customized to form a default geofence whenever the mode is initiated. The geofence may include outer boundaries for the vehicle. The geofence may be formed with a mileage radius, which may be a default radius or customized by the user. For example, the server may instruct the OBD to monitor the vehicle to determine if it travels more than 0.5 miles outside the radius of the geofence, with the centerpoint being the current location of the vehicle or any point within a parking facility. If the OBD determines that the mileage radius has been exceeded or reached, the OBD may transmit a message to the server, which may transmit an alert to the user that radius has been exceeded or reached.

An exemplary embodiment may include an automobile diagnostic controller in serial communication with a vehicle. The controller may include a housing. The housing may include a plurality of OBD-II compliant pins, the pins forming a connection with an OBD-II port, the OBD-II port in communication with an on-board vehicle processor. The housing may further include a wireless receiver, the wireless receiver configured to receive, from the on-board vehicle processor, any or all of: a unique telephonic numeric identification number associated with the controller, an IMEI identification number, an Internet Protocol address, and an initial command sequence via an SMS protocol.

The housing may further include a wireless transmitter. The transmitter may be configured to transmit, to the on-board vehicle processor, instructions to initiate the sequence protocols for the controller. The instructions may include, any or all of: assigning an Access Point Name (APN) gateway identifying the Packet Data Network (PDN), assigning a port channel between the controller and the on-board vehicle processor, assigning a unique SMS identifier number to the controller, assigning a communication protocol for communication between the controller and the on-board vehicle processor, and vehicle diagnostic pin-readouts. The pin-readouts may include GPS coordinates.

The controller may be further configured to receive a query, via the receiver and transmit, via the transmitter, a query response command. The query response command may include data packet transmission of a geofence coordinate activation sequence. The geofence coordinate activation sequence may include data packet transmission of a first series of geolocation coordinates from a GPS antenna, data packet transmission of a second series of geolocation coordinates from a GPS antenna, and/or a tagged sequence initiation for associating vehicular location with geofence coordinate disruption, based on the first series and the second series including coordinate data packet disruptions.

To initiate retrieval of the vehicle, the user may then transmit a message, or select an option, to retrieve the vehicle. In response, the server may transmit a query to the OBD device. The query may be a location query to determine the current location of the vehicle. The query may include a request to retrieve the vehicle.

The location query may further include (1) querying the GPS location of the vehicle; (2) determining the GPS coordinates of the vehicle from the GPS antenna located within the OBD device and/or the vehicle; and (3) transmitting the GPS coordinates of the vehicle to the server.

The location query may include (1) querying the GPS location of the user; (2) determining the GPS location of the user from GPS information determined by the GPS antenna located within the user's mobile device; and (3) transmitting the GPS coordinates of the user and/or vehicle to the server.

In response to the query, the server may receive the location of the vehicle. The response may be sent by the valet/parking facility. Alternatively, the server may query the location, and the OBD device may respond with the GPS coordinates of the OBD/vehicle. As a result, the server may form a geofence, using a mileage radius. The mileage radius may then be converted into a plurality of GPS coordinates on a map. The mileage radius may be predetermined, or may be input by a user.

The system may transmit, from the server to the OBD device coupled to the vehicle, one or more geofence parameters. For example, the geofence parameters may include a permissible area within the geofence, an impermissible area outside the geofence, areas that are permissible or impermissible at specified times, or any other suitable parameters. The system may transmit, from the server to the OBD device, an instruction to monitor the vehicle. The monitoring may include monitoring the vehicle for one or more violations. The violations may be geofence violations. The OBD device may be further instructed to transmit an alert to the server when one or more of the geofence parameters are violated.

In an embodiment, the system may receive one or more parameter restriction thresholds for a vehicle. For example, the parameters may include speed, acceleration, deceleration, geofencing, time of day, duration, or any other suitable parameter. The threshold may be a threshold for a restriction, such as speed above 60 MPH is restricted.

The parameter restriction thresholds may include one or more values. The values may be predetermined, or may be input by a user. The user may input parameter restriction threshold values by (1) transmitting, to the server, a parameter; (2) transmitting, to the server, a restriction for the parameter, the restriction including a threshold value; and (3) transmitting an instruction to the OBD device to monitor the parameter to determine if the threshold level is exceeded or reached.

The system may receive an instruction from a user. The user may input the instruction into an application or any other suitable medium, via a user interface. The instruction may then be transmitted to a server. The instruction may be an instruction to activate parameter restriction thresholds. The activation of the restriction thresholds may be requested when the user utilizes a valet or parking facility. The valet restriction function may cause the server to instruct the OBD device to monitor the vehicle for violation of one or more parameter restriction thresholds.

The system may transmit, from the server to the OBD device coupled to the vehicle, a speed query for the vehicle. The speed query may request the speed of the vehicle at multiple points in time, to determine if the vehicle is speeding and has violated one or more parameter restriction thresholds. The speed query may include a first point in time and a second point in time, and an instruction, from the server to the OBD device, to analyze speed information between the first point in time and the second point in time, to determine if the speed threshold has been exceeded or reached at any point between the two points in time. In return, the server may receive from the OBD device a determination. The determination may include a speed determination if the speed threshold has or has not been exceeded or reached.

If the OBD device determines that the speed threshold has been exceeded or reached between the first point in time and the second point in time, the OBD device may transmit a message to the server with information about the speed violation. If the OBD device determines that the speed threshold has not been exceeded or reached between the first point in time and the second point, the OBD may refrain from transmitting data about the speed threshold from the OBD device to the server. Alternatively, if a query is transmitted to the OBD to determine if the speed threshold has been violated, the OBD device may transmit a message that no violation has occurred.

If the OBD determines that the speed threshold is exceeded or reached between the first point in time and the second point in time, the system may transmit an alert. The alert may be transmitted from the user server to the user. The alert may inform the user that the speed threshold has been exceeded or reached.

In one embodiment, the system may (1) receive one or more parameter restriction thresholds for a vehicle; (2) receive an instruction from a user to enable a valet restriction function, the valet restriction function corresponding to monitoring the vehicle for violating one or more parameter restriction thresholds; (3) transmit, from the server to an OBD device coupled to the vehicle, an acceleration query for the vehicle, the acceleration query comprising a query to determine if the vehicle has violated the one or more parameter restriction thresholds, the acceleration query comprising: (4) a first point in time and a second point in time; and (5) an instruction to the OBD device to analyze the rate of speed acceleration between the first point in time and the second point in time to determine if the acceleration rate threshold has been exceeded or reached; and (6) receive, from the OBD device, the determination, wherein: (7) if the OBD determines that an acceleration rate threshold has been exceeded or reached between the first and second point in time, transmitting a message from the OBD to the server; and (8) if the OBD determines that an acceleration rate threshold has not been exceeded or reached between the first and second point in time, there is no message from the OBD device to the server corresponding to the acceleration threshold from the OBD to the server.

The acceleration and/or deceleration may be calculated using one or more well-known algorithms or formulas for acceleration and/or deceleration.

A system for monitoring valet attendants and parking facility usage of a vehicle is provided. The system may include an apparatus and method, and may provide monitoring of vehicle conditions when the vehicle is valeted.

The system may include receiving an instruction from a user. The user instruction may request to initiate a specified mode, such as a valet monitoring mode. The mode may include a vehicle retrieval mode, to be used in requesting retrieval of a vehicle.

In the vehicle retrieval mode, the system may receive a request from the user. The request may be a request to retrieve the vehicle. The request may be received by a server. The system may identify the valet or parking company associated with the of the vehicle. The location may be the location of the vehicle at the time the user requests to retrieve the vehicle, or at the time the user initiates valet mode.

The valet or parking company may be determined by determining a GPS location. The GPS location may be the GPS location of the vehicle, or the GPS location of the user's mobile device when the valet mode was activated. The system may determine the entity associated with the location of the vehicle, and determine contact information for the entity. The system may transmit, from the server to the entity, a request to retrieve the vehicle. The request may include an instruction to the valet attendant to prepare the vehicle for pickup by the user. The request may further include an instruction to the valet attendant to bring the vehicle to a specified location, such as GPS coordinates input by the user. For example, the user may instruct a valet to retrieve the vehicle from one location, and bring the vehicle to a completely separate location.

The system may receive, from the entity, an estimated time when the vehicle will be available for pickup, as well as the location where the vehicle be available for pickup. The system may provide, to the user, status monitoring the vehicle. The status monitoring may include GPS coordinates of the vehicle, ignition status of the vehicle, and movement of the vehicle. Movement of the vehicle may include whether the vehicle is in motion, whether it has been in motion within a recent period of time (i.e., the last 10 minutes), and real-time tracking of the vehicle movements.

A system for providing monitoring of vehicle conditions when the vehicle is valeted may also include a measurement device. The measurement device may be removably connected to a vehicle. The system may also include a computer. The computer may include a connection to the measurement device. The computer may be located within the vehicle. The computer may be an onboard vehicle computer.

The system may further include a receiver. The receiver may be configured to receive, from the user, a request to retrieve the vehicle. The vehicle may be parked in a location managed by a valeting entity.

The system may further include a processor. The processor may be configured to identify the entity responsible for the valeting location. The processor may be configured to identify the entity based on GPS coordinates. The entity may be identified from the GPS coordinates based on the system retrieving, using the GPS coordinates, a business at those coordinates. This may be accomplished using mapping software. The GPS coordinates of the entity may be retrieved from the vehicle itself, from the GPS antenna within the OBD device, from the user's mobile device when the user activates the valet mode, or when the user manually enters the GPS location of the vehicle.

The system may further include a transmitter. The transmitter may be configured to transmit, to the entity, an instruction to an attendant to retrieve the vehicle. The transmitter may be further configured to transmit, to the entity, GPS coordinates for the vehicle. Throughout this application, the transmitter and receiver may be a transceiver.

The receiver may be further configured to receive, from the entity, an estimated time when the vehicle will be ready for pickup. The transmitter may be further configured to transmit, to the user, the estimated location of the vehicle and the estimated time when the vehicle will be ready for pickup.

The system may further receive tracking information for the location of the vehicle in real-time, or at predetermined intervals. The system may also receive a message form the entity that the vehicle is ready for pickup.

A system for providing monitoring of vehicle conditions may include: (1) a measurement device removably connected to a vehicle; (2) the measurement device comprising a connection with a computer, the computer located within the vehicle; (3) a receiver configured to receive, from the measurement device, measurement of data corresponding to an attribute of the vehicle; (5) a transmitter configured to transmit, to the measurement device, a threshold measurement corresponding to a desired data measurement level for the vehicle attribute; and (6) a processor located within the measurement device configured to: determine if the threshold measurement is exceeded or reached by the data measurement; and instruct a transmitter to transmit, to a user, an alert that the data measurement for the vehicle attribute has been exceeded or reached.

The system may perform the following steps: (1) receiving a vehicle attribute; (2) receiving a threshold range for the measurement of the vehicle attribute, the threshold range comprising an upper threshold measurement and a lower threshold measurement of the vehicle attribute; (3) receiving a measurement of the vehicle attribute; (4) if the vehicle attribute measurement exceeds the upper threshold measurement or falls below the lower threshold measurement, transmitting, to a user, an alert comprising: (5) the vehicle attribute; (6) the measurement of the vehicle attribute; and (7) information corresponding to the measurement of the vehicle attribute.

A system for setting and monitoring vehicle usage thresholds may include (1) a measurement device removably connected to a vehicle; (2) the measurement device comprising a connection with a computer, the computer located within the vehicle; (3) wherein upon connection of the measurement device to the computer, the measurement device receives vehicle information from the computer; (4) a user device configured to: (5) transmit one or more instructions to the measurement device; (6) receive information; and (7) display information; (8) a server comprising: a receiver configured to receive: (9) a plurality of thresholds, each of the plurality of thresholds corresponding to an allowable limit of a vehicle attribute; (10) data from the measurement device; and (11) instructions to monitor data received from the measurement device, the data corresponding to one or more vehicle attributes; (12) a transmitter configured to: (13) transmit the plurality of thresholds to the measurement device; (14) instruct the measurement device to: (15) compare the data received from the vehicle computer to the threshold level; and (16) if the data exceeds the threshold level, transmit a message to the server of a threshold violation.

In response to the server receiving the threshold violation message, the transmitter may be further configured to transmit an alert of the threshold violation to the user.

In one embodiment, certain information, such as a threshold for an attribute, may be received from a user, via the user's mobile device, and transmitted to the server. In another embodiment, certain information, such as another threshold for the same or different attribute, may be programmed into the server via software.

In one embodiment, measurement of data corresponding to an attribute of the vehicle is provided. The measurement may include (1) a threshold measurement corresponding to a desired data measurement level for the vehicle attribute; and (2) a processor configured to: determine if the threshold measurement is exceeded or reached by the data measurement; and instruct a transmitter to transmit, to a user, an alert that the data measurement for the vehicle attribute has been exceeded or reached.

A system and method for infant monitoring of a vehicle using an OBD device is provided. The method and system may include one or more of the following steps: (1) receiving a selection from a user to enable infant monitoring mode; (2) receiving an alert from the OBD that the ignition has been switched off; (3) transmitting a message to the user comprising: (4) an alert that the ignition has been switched off; and (5) a query if the user has removed all children from the vehicle; (6) if the user does not respond to the query within a predetermined period of time, transmitting an instruction to the OBD to activate a microphone; (7) if the microphone does not indicate that any noise over a predetermined threshold is present, and there is still no response from the user, transmitting an instruction to activate a temperature sensor; (8) if the temperature sensor indicates a temperature reading above a predetermined threshold or below a predetermined threshold, transmitting an instruction to the OBD device to activate heat or air conditioning systems, and (9) contacting emergency first responders.

It should be noted that some or all of the steps may be implemented, and that the order of the steps may be altered. For example, only a temperature sensor may be used, or the temperature may be used prior to use of the microphone.

The system may further include transmitting location information to emergency first responders. The system may receive an alert that the ignition is on, but the car is idle for an extended period of time. The system may, in response, transmit a message to the user to determine if there is an unattended child in the vehicle. If there is no response, the system may activate some or all of the steps discussed.

The system may receive a response from the user to the query. In response to the query if the user has removed all children from the vehicle, the system may receive an affirmative response from the user. In that case, the alert sequence may end, and no further action, such as activating sensors or contacting emergency authorities, is necessitated.

The system may prioritize resources based on a determination of the urgency of each particular situation. For example, if there are two SBM alerts that require an emergency operator to contact the local PSAP, and only one operator is available, the system may prioritize one situation if the device temperature monitor detects rapidly rising or falling temperatures in one vehicle. This is just an example of one way to prioritize. A prioritization system is essential for handling emergency situations. In another example, if one PSAP has the ability to receive information on emergencies via the interne or email, but another PSAP does not have that ability, the PSAP without online capabilities may be contacted first. It should be noted that the priority may be changed based on time, child age, and many other factors.

Carpool mode may provide the ability to coordinate and organize carpool trips. The system may include providing a (for example, weekly) template schedule which is used by the system to produce a, for example, weekly schedule, which can be manipulated by the carpool participants. The carpool participants may create a week-based template schedule for a week and this template creates the schedule for the current week. The current week may be editable. Subsequent weeks may not be editable, because they have not yet been created based on the template schedule.

For carpool, the template schedule is a week long, because carpool is usually a weekly function. For example, one family is responsible for Monday and Wednesday, and another family is responsible for Tuesday, Thursday, and Friday. This concept of using a template to create a weekly schedule applies to any scheduling system, and the unit of time may change based on the particular activity. For example, the week may start on a specific day, which means that the template will refresh a weekly schedule on a specific day, or the week may be a rolling week, and will display 7 days from current day.

A carpool may provide a plurality of waypoints, with responsibilities assigned to one or more participants. Provided is a system for managing coordination of waypoints and integration of carpool waypoints with other transportation systems.

The carpool system provides drivers the option to change the order or quantity of carpool stops on a web application, with the order of the waypoints saved as a template. The existing template for the driver may be used for the order of stops for that driver. If no member of the driver's household is going to be a part of a specified carpool run, the household is deleted from the waypoint. If the address for a member of the carpool changes, the waypoint/address for that member changes.

If members of a carpool group have identical waypoints, the waypoints are merged, and one of the waypoints is deleted but the users are each associated with the remaining waypoint. If one of those members subsequently moves to a new address, the waypoints are unmerged and a new one is created with the new address and the proper user associated with that address.

In one embodiment, the system may detect a change in the waypoint, even if the driver does not notify the system of changes based on the driver's route. The notification may include sending a notification to users associated with a waypoint. The notification may include Estimated Time of Arrival (ETA) to the waypoint.

An exemplary detection may include, determining that there are five waypoints and two routes to each waypoint. If, based on the driver's route, all eight routes that go to four of the waypoints are eliminated, the driver must be going to the fifth waypoint. If all 10 routes are eliminated, it is known that the driver is not going to any of the waypoints. To eliminate routes and determine the waypoints, the route should be defined, with Route=rectangular geofences from point A to point B. To determine that a driver is going off of a route, the system starts with the most likely or best route, using any suitable determination method, such as Waze or Google Maps data. The system may then create rectangular geofences all the way from point A to point B. If the driver violates the route, the system may wait a certain amount of time, such as any suitable time period, such as two minutes, and then check the route from current location to point B, using mapping software, and determines a change in ETA. If the ETA has decreased down by the elapsed amount of time+a certain threshold, the user is still considered on the route. However, if the ETA went up by a certain threshold, the driver is determined to be off the route.

In one embodiment, the carpool system may be integrated with other modes of transportation. For example, if two passengers take the same train and live near one another, they can carpool to the train station. Integrating the carpool system with the monitoring of the location of the other transport vehicles, allows for the creation of a hub and spoke system. Furthermore, GPS accuracy and arrival time can be utilized to project or coordinate transfers in hub and spoke system.

In carpool mode, when a driver deviates onto an impermissible route, an alert is sent to other parents and/or the school. The alert may be sent at a predetermined time threshold or distance threshold, such as when the deviation is greater than five minutes or more than 0.5 miles. The alert may further include a statement that the carpool will be late to school, and may include a revised estimated time of arrival.

It will be understood by those skilled in the art that each of the above steps will comprise computer-implemented aspects, performed by one or more of the computer components described herein. For example, communications and calculations of thresholds may be performed electronically. Determination of threshold violations, monitoring parameters, and communicating the threshold violations may be performed electronically. In at least one exemplary embodiment, all steps may be performed electronically—either by general or special purpose processors implemented in one or more computer systems such as those described herein.

It will be further understood and appreciated by one of ordinary skill in the art that the specific embodiments and examples of the present disclosure are presented for illustrative purposes only, and are not intended to limit the scope of the disclosure in any way.

Accordingly, it will be understood that various embodiments of the present system described herein are generally implemented as a special purpose or general-purpose computer including various computer hardware as discussed in greater detail below. Embodiments within the scope of the present invention also include computer-readable media for carrying or having computer-executable instructions or data structures stored thereon. Such computer-readable media can be any available media which can be accessed by a general purpose or special purpose computer, or downloadable through communication networks. By way of example, and not limitation, such computer-readable media can comprise physical storage media such as RAM, ROM, flash memory, EEPROM, CD-ROM, DVD, or other optical disk storage, magnetic disk storage or other magnetic storage devices, any type of removable non-volatile memories such as secure digital (SD), flash memory, memory stick etc., or any other medium which can be used to carry or store computer program code in the form of computer-executable instructions or data structures and which can be accessed by a general purpose or special purpose computer, or a mobile device.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the invention may be implemented. Although not required, the inventions are described in the general context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, objects, components, data structures, etc. that perform particular tasks or implement particular abstract data types, within the computer. Computer-executable instructions, associated data structures, and program modules represent examples of the program code for executing steps of the methods disclosed herein. The particular sequence of such executable instructions or associated data structures represent examples of corresponding acts for implementing the functions described in such steps.

Those skilled in the art will also appreciate that the invention may be practiced in network computing environments with many types of computer system configurations, including personal computers, hand-held devices, multi-processor systems, microprocessor-based or programmable consumer electronics, networked PCs, minicomputers, mainframe computers, and the like. The invention is practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the inventions, which is not illustrated, includes a general purpose computing device in the form of a conventional computer, including a processing unit, a system memory, and a system bus that couples various system components including the system memory to the processing unit. The computer will typically include one or more magnetic hard disk drives (also called “data stores” or “data storage” or other names) for reading from and writing to. The drives and their associated computer-readable media provide nonvolatile storage of computer-executable instructions, data structures, program modules, and other data for the computer. Although the exemplary environment described herein employs a magnetic hard disk, a removable magnetic disk, removable optical disks, other types of computer readable media for storing data can be used, including magnetic cassettes, flash memory cards, digital video disks (DVDs), Bernoulli cartridges, RAMs, ROMs, and the like.

Computer program code that implements most of the functionality described herein typically comprises one or more program modules may be stored on the hard disk or other storage medium. This program code, as is known to those skilled in the art, usually includes an operating system, one or more application programs, other program modules, and program data. A user may enter commands and information into the computer through keyboard, pointing device, a script containing computer program code written in a scripting language or other input devices (not shown), such as a microphone, etc. These and other input devices are often connected to the processing unit through known electrical, optical, or wireless connections.

The main computer that effects many aspects of the inventions will typically operate in a networked environment using logical connections to one or more remote computers or data sources, which are described further below. Remote computers may be another personal computer, a server, a router, a network PC, a mobile device, such as a smartphone, tablet or laptop, a peer device or other common network node, and typically include many or all of the elements described above relative to the main computer system in which the inventions are embodied. The logical connections between computers include a local area network (LAN), a wide area network (WAN), and wireless LANs (WLAN) that are presented here by way of example and not limitation. Such networking environments are commonplace in office-wide or enterprise-wide computer networks, intranets and the Internet.

When used in a LAN or WLAN networking environment, the main computer system implementing aspects of the invention is connected to the local network through a network interface or adapter. When used in a WAN or WLAN networking environment, the computer may include a modem, a wireless link, or other means for establishing communications over the wide area network, such as the Internet. In a networked environment, program modules depicted relative to the computer, or portions thereof, may be stored in a remote memory storage device. It will be appreciated that the network connections described or shown are exemplary and other means of establishing communications over wide area networks or the Internet may be used.

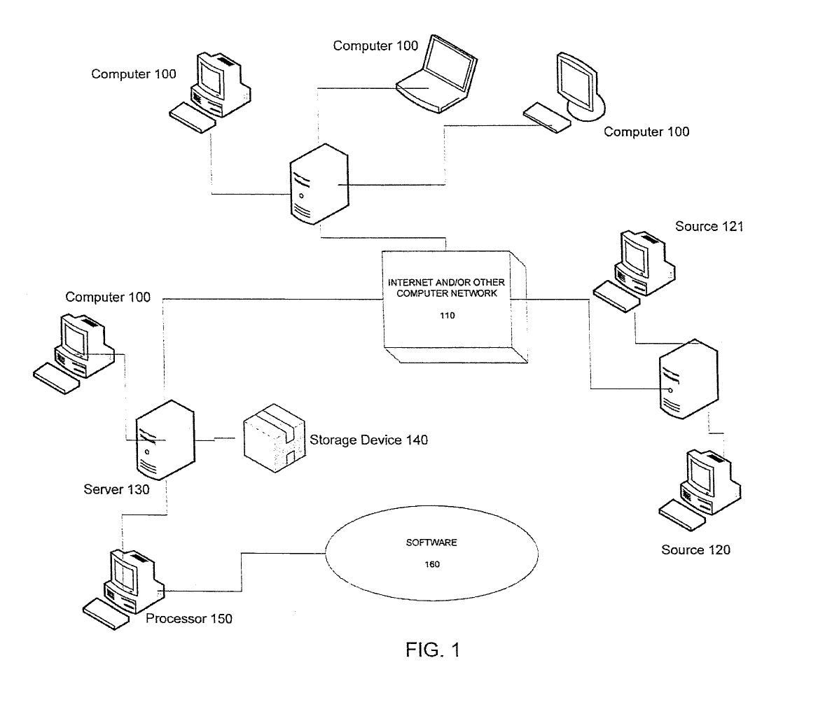

An exemplary such system is depicted in FIG. 1. Computers 100 communicate via network 110 with a server 130. A plurality of sources of data 120-121 also communicate via network 110 with a server 130, processor 150, and/or other components operable to calculate and/or transmit information. Server(s) 130 may be coupled to one or more storage devices 140, one or more processors 150, and software 160.

Calculations described herein, and equivalents, are, in an embodiment, performed entirely electronically. Other components and combinations of components may also be used to support processing data or other calculations described herein as will be evident to one of skill in the art. Server 130 may facilitate communication of data from a storage device 140 to and from processor(s) 150, and communications to computers 100. Processor 150 may optionally include or communicate with local or networked storage (not shown) which may be used to store temporary or other information. Software 160 can be installed locally at a computer 100, processor 150 and/or centrally supported for facilitating calculations and applications.

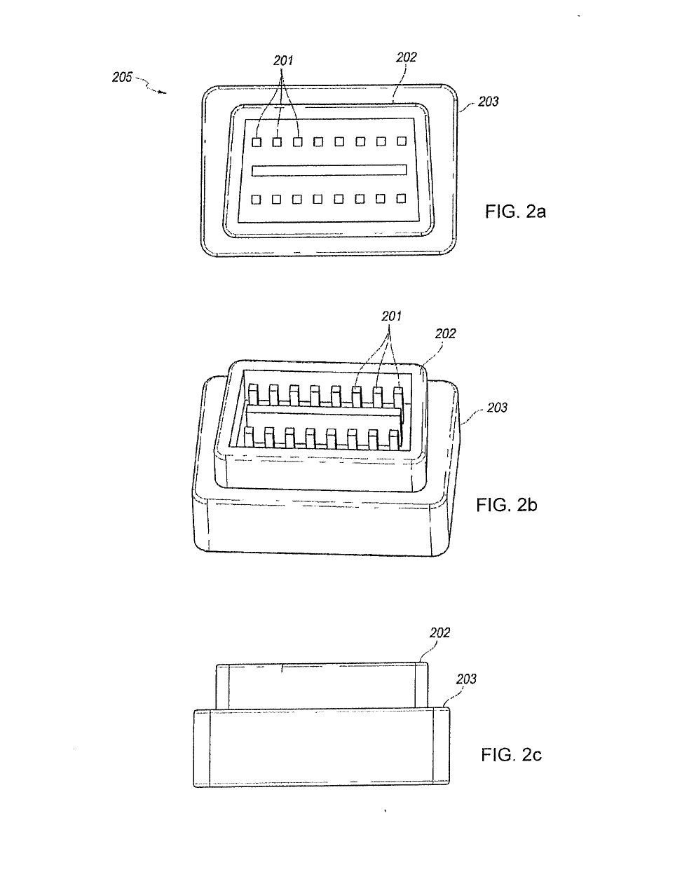

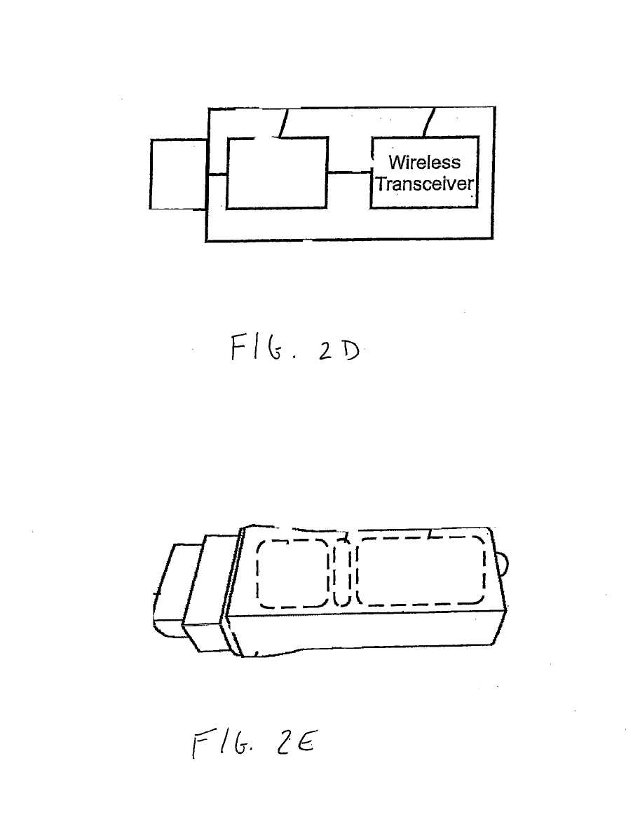

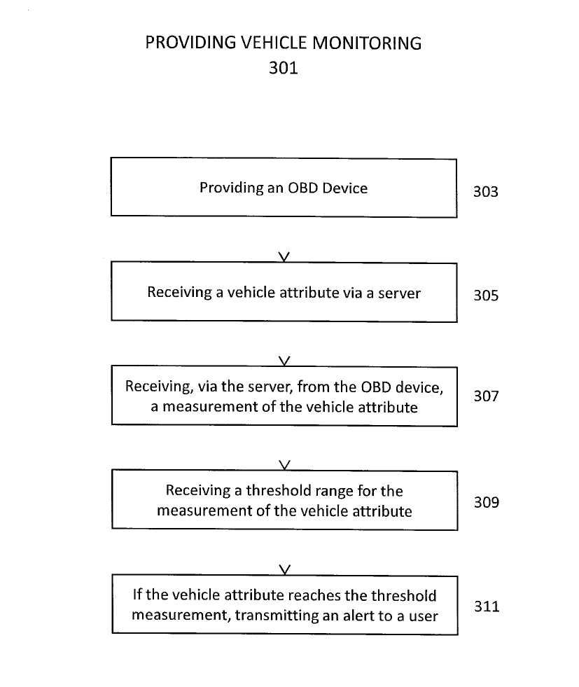

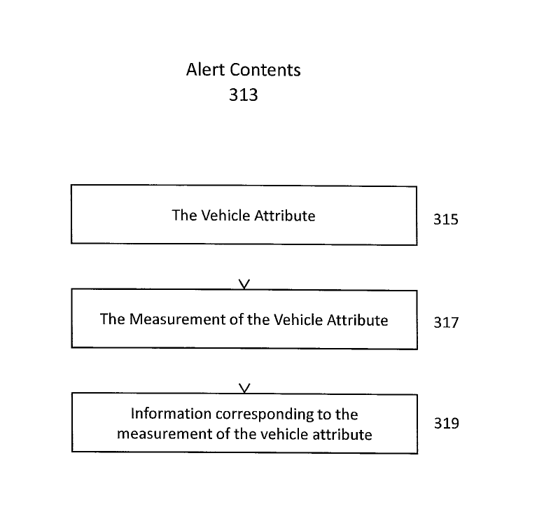

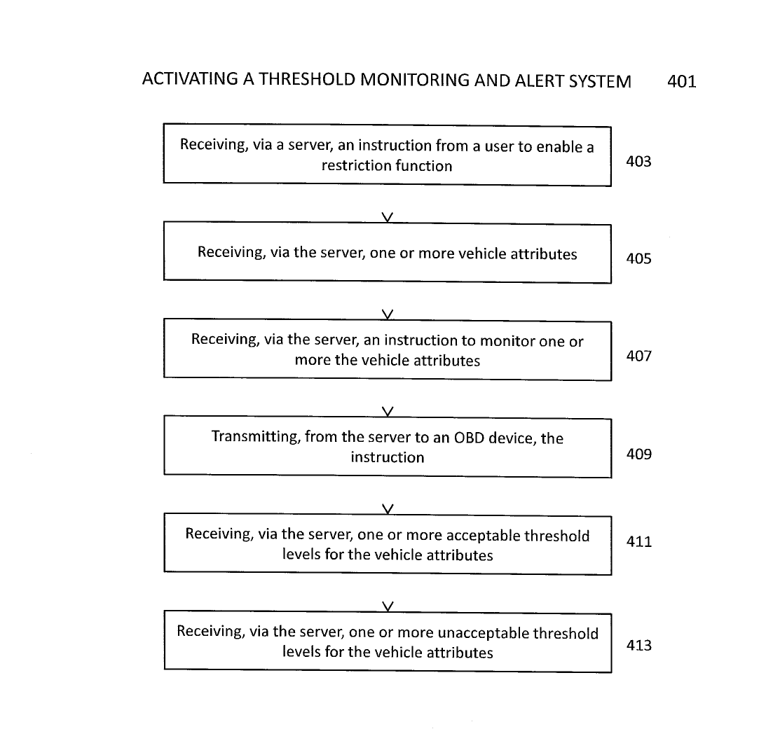

FIG. 2A illustrates a top view of an OBD device 205 that may be used in accordance with the invention. OBD device 205 may include a plurality of electrical connectors, or pins 201. Pins 201 may be configured to communicate with an OBD port of a vehicle. OBD device 205 may be configured to receive diagnostic information from the vehicle's OBD system.

FIG. 2B illustrates a perspective top and side view of OBD device 205. FIG. 2C illustrates a side view of the OBD device.

FIG. 2D illustrates another view of OBD device 205. FIG. 2E illustrates a side view of OBD device 205, with a protrusion for holding pins.

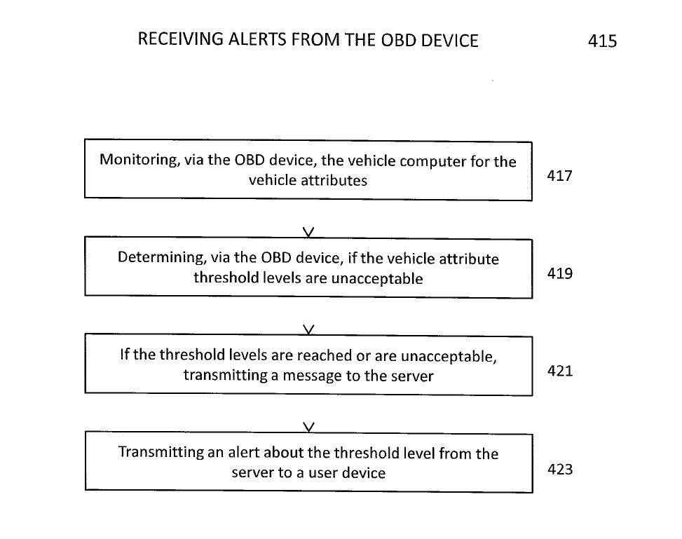

FIG. 3A illustrates an exemplary process 301 for providing vehicle monitoring in accordance with principles of the invention. At step 303, an OBD device may be provided. At step 305, a vehicle attribute may be received via server. At step 307, the server may receive a measurement of the vehicle attribute from the OBD device. At step 309, a threshold range for the measurement of the vehicle attribute may be received by the server and/or OBD device. At step 311, if the vehicle attribute reaches the threshold measurement, an alert is transmitted to a user.

FIG. 3B illustrates exemplary process 313 for transmitting alerts in accordance with the principles of the invention. Process 313 provides the information that is transmitted in an alert. The alert may contain vehicle attribute 315, measurement of the vehicle attribute 317, and information corresponding to the measurement of the vehicle attribute 319.

FIG. 4A illustrates exemplary process 401 for activating a threshold monitoring and alert system in accordance with the principles of the invention. At step 403, the system may receive an instruction from a user to enable a restriction function. The instruction may be received via a server. At step 405, the system may receive, via the server, one or more vehicle attributes. At step 407, the system may receive, via the server, an instruction to monitor one or more of the vehicle attributes. At step 409, the system may transmit the instruction from the server to an OBD device. At step 411, the system may receive one or more acceptable threshold levels for the vehicle attributes via the server. At step 413, the system may receive one or more unacceptable threshold levels for the vehicle attributes via the server.

FIG. 4B illustrates exemplary process 415 for receiving alerts from the OBD device in accordance with principles of the invention. At step 417, the OBD device may monitor the vehicle computer for one or more vehicle attributes. The vehicle attributes may be programmed into the OBD device. At step 419, the OBD device may determine if the vehicle attribute threshold levels are unacceptable, such as if a threshold level has been exceeded. At step 421, the OBD device may transmit a message to the server if the threshold levels are reached or are unacceptable. At step 423, the an alert about the threshold level may be transmitted from the server to a user device.

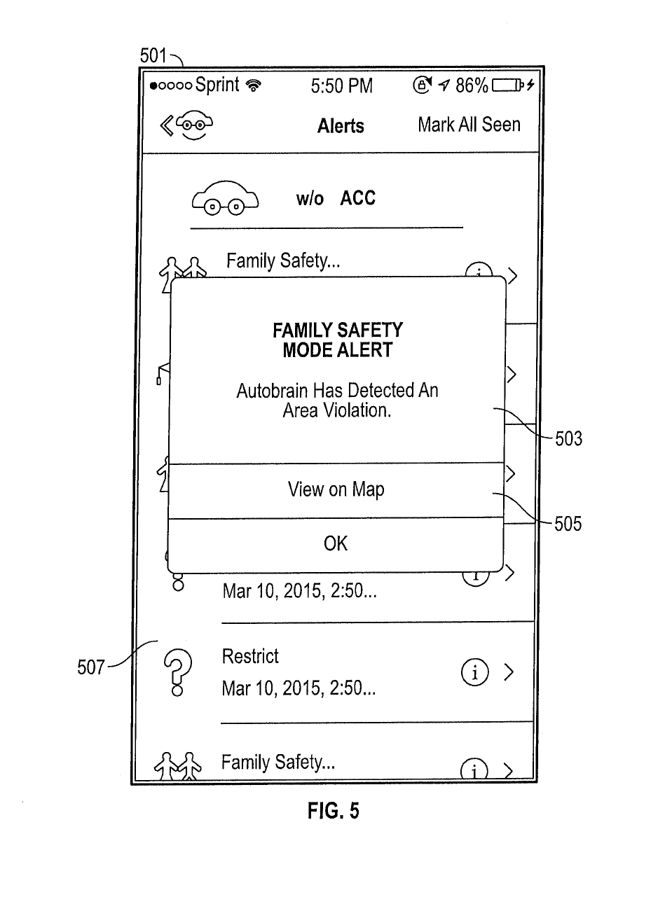

FIG. 5 shows illustrative display 501 in accordance with the invention. Display 501 may be an alert displayed to a user in response to a threshold violation. 503 shows an area violation, such as a geofence violation, has occurred, within the setting ‘Family Mode.’ The user has the option to select the violation and view on map 505. 507 is a background display showing other violations.

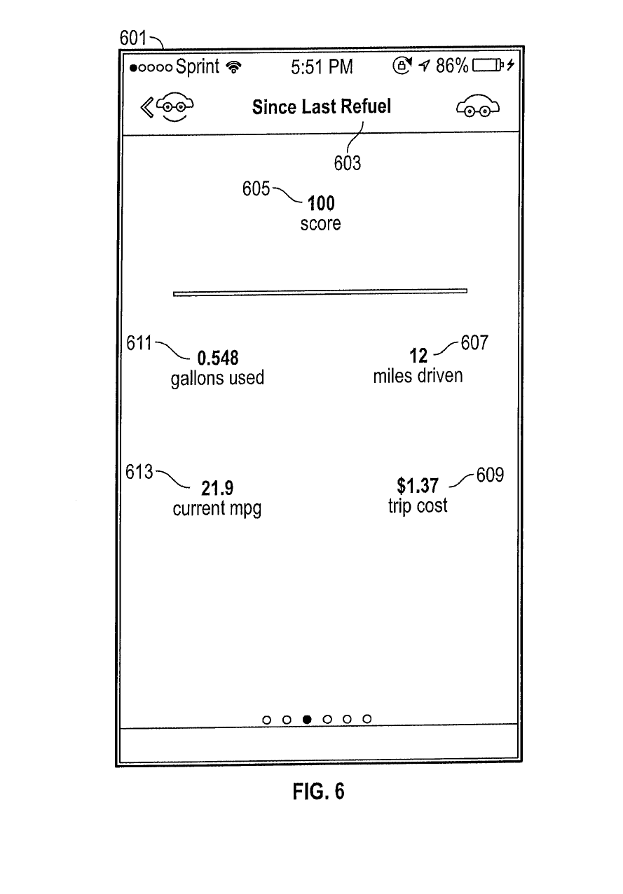

FIG. 6 shows illustrative information 601 monitored by the OBD device. 601 is a user display. In this embodiment, 603 shows that the information is fuel consumption since the last refuel, and 605 is the user score provided for driving since last refuel. In this case, 605 shows ‘100’ as a perfect score for driving, based on an algorithm. The details of the driving for calculating the score are show in in 607, 609, 611, and 613.

In one embodiment, fuel consumption may be monitored. The OBD may be configured to determine expected fuel usage for a vehicle based on analyzing past vehicle fuel utilization models. The OBD may be further configured to determine expected fuel costs for the vehicle based on the determined expected usage.

In accordance with the invention, the OBD may receive an instruction to lock in a fuel price, such as a transmission from a mobile computing device. The fuel price may be “locked-in” or set for a predetermined period of time, without requiring a locked specified quantity or delivery schedule. Thus, a third-party, such as a fuel company, may transmit an instruction to the OBD to retrieve data associated with fuel usage, such as miles driven and driving habits (such as braking habits, percentage of highway or road driving, average speed, weather patterns) and determine an expected quantity of fuel needed for the vehicle over a given period of time. For example, the third-party may retrieve data associated with a three-month winter period from a previous year, and estimate expected fuel usage for the same upcoming winter period. The third-party may then absorb the risk associated with hedging the fuel cost, without input from the driver of the vehicle.

In a further example, at a point-of-sale terminal at a gas station, the vehicle driver may submit payment for a determine amount of fuel via any suitable format, such as a credit/debit card. The bank associated with the payment card may then transmit a data packet query to the third-party company, which may then retrieve the locked-in fuel price for the OBD associated with the vehicle. If the third-party determines that the true cost of the fuel exceeds the locked-in price, the third-party transmits the locked-in price to the bank, along with an instruction to transmit, via the internet banking system, the difference in price between the true cost and the locked-in cost from the third-party to the bank.

The OBD may receive further instructions to impose minimum and maximum limits for quantity of fuel that may be locked-in. The OBD is additionally configured to continuously monitor fuel consumption and driving habits, and transmit data associated with the driving to the third-party. As a result, quantifiable data, such as braking habits, and mass air-flow, may be utilized by the third-party to adjust the limits of fuel that may be locked-in based on calculated fuel consumption.

The OBD may therefore provide a dynamic pricing system for a vehicle by monitoring fuel usage for the vehicle, determine the fuel needs for the vehicle, lock in a price for the vehicle for a predetermined period of time, and allow the vehicle to fill up with fuel at the gas station at a predetermined price. In order to maintain precise hedging, the OBD may be uniquely associated with only one vehicle, so as to only calculate the precise fuel needs for that vehicle.

Thus, the OBD is configured to receive a one-time vehicle association identifier via the pin connectors. After receiving the initial identifier, the OBD will query the vehicle for an identifier each subsequent time that it encounters pin connectors. If the vehicle identifier does not match the initial identifier, the OBD may transmit an instruction to the third-party that terms of the locked-in program have been violated. Additionally, the OBD may prevent further locking in of prices, and may refuse to receive instructions to lock in pricing.

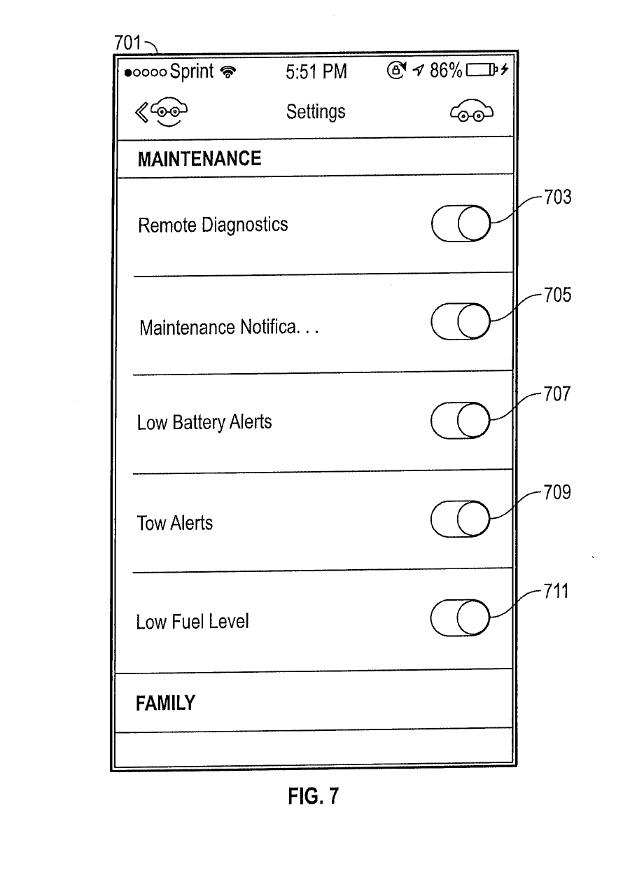

FIG. 7 shows illustrative settings display 701 in accordance with the invention. In this case, the user has enabled various features, which may be toggled on or off. Enabling of these features allows the user to receive alerts. The user has enabled diagnostics 703, maintenance notifications 705, low battery alerts 707, tow alerts 709, and low fuel level 711. Thus, when any of these thresholds or scenarios are triggered, the user may receive notifications or alerts.

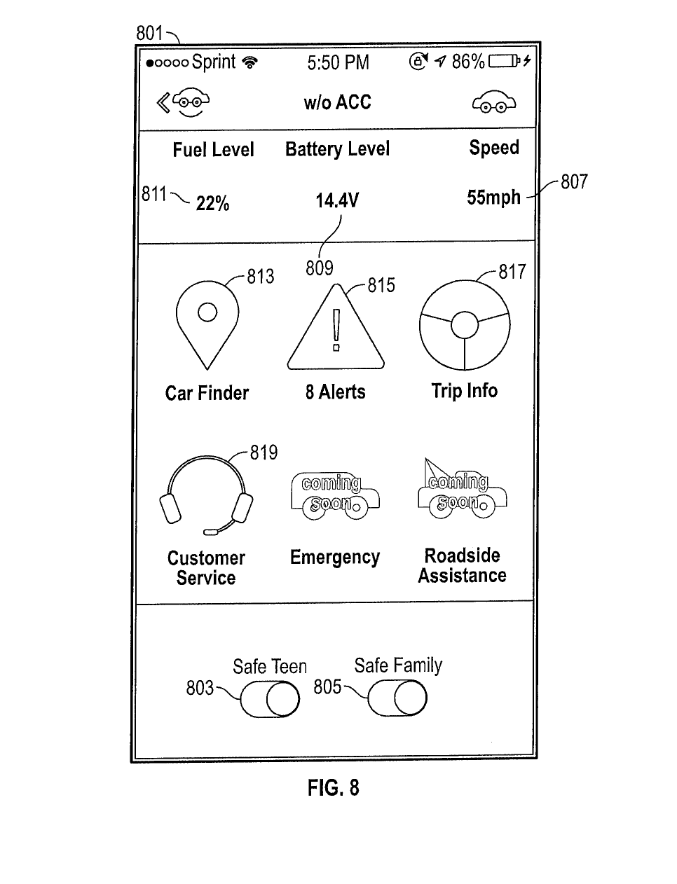

FIG. 8 shows illustrative dashboard 801 in accordance with the invention. Shown is fuel level 811, battery level 809, and speed 807. This information may be provided in real time. That is, an administrator of a vehicle and/or OBD device may monitor the speed and other levels of the vehicle at any given time. Also provided is car find 813, which, when selected, shows the location of the vehicle. Alert selector 815 displays one or more notifications and alerts, while trip info 817 displays different information about a trip. Customer service selector 819 allows a user to contact customer service within the application, and transmits information about the user's vehicle with the call. Safe Teen 803 and Safe Family 805 are two modes that are toggled on, with monitoring of various thresholds enabled.

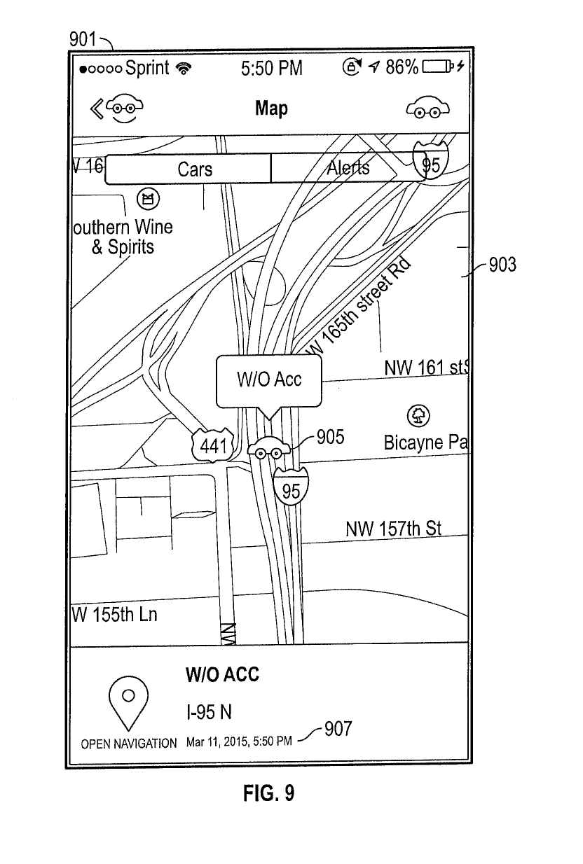

FIG. 9 is the result when car finder 813 is selected, showing map 901. 905 is the location of the vehicle with the OBD device, 903 is additional map information, and 907 includes particulars such as date and time.

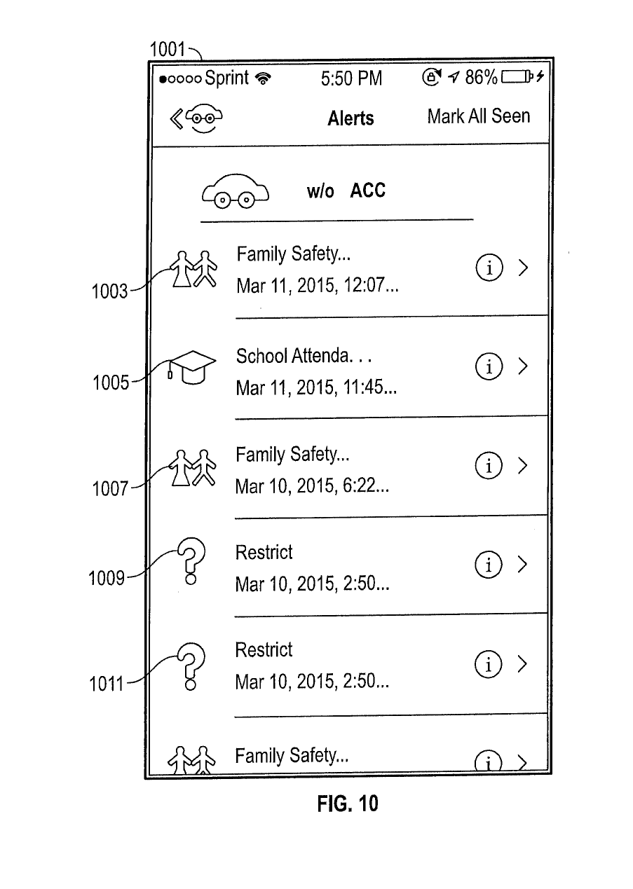

FIG. 10 shows additional alerts in accordance with the invention.

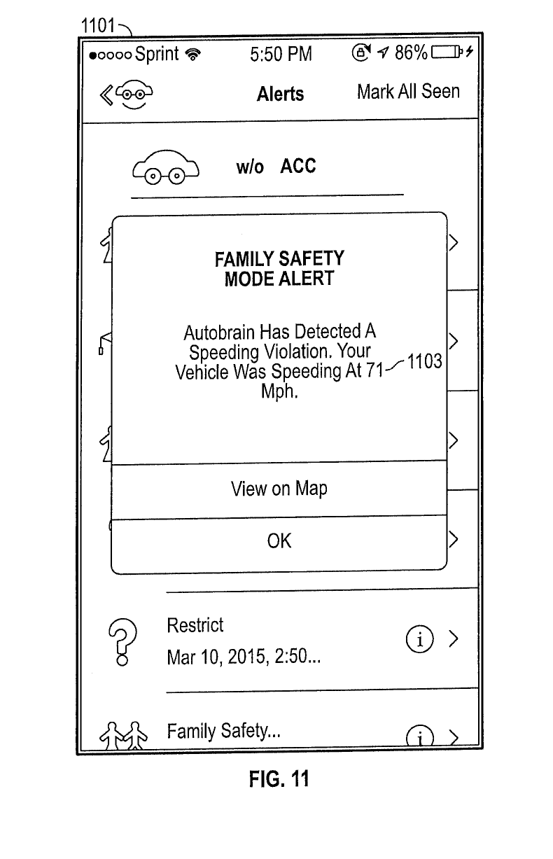

FIG. 11 displays alert 1101, with information 1103 including detailed information about the violation, such as the speed detected.

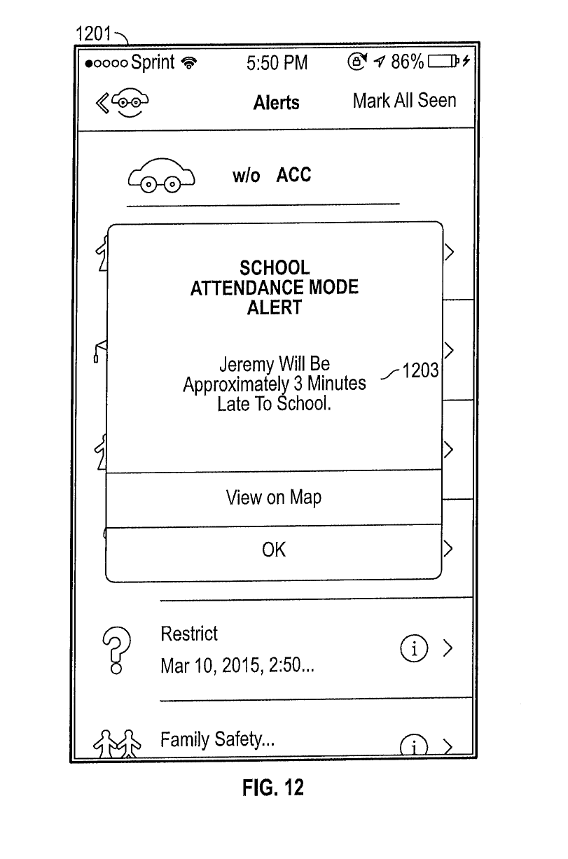

FIG. 12 displays another exemplary alert 1201, including particular information about the threshold violation detection in display 1203. It should be noted that the approximate violation may be calculated in advance. Thus, in this case, traffic patterns may dictate that, though a user has left ten minutes before an appointment, using traffic data, it may be estimated that the user will arrive three minutes late.

In view of the foregoing detailed description of preferred embodiments of the present invention, it readily will be understood by those persons skilled in the art that the present invention is susceptible to broad utility and application. While various aspects have been described in the context of a preferred embodiment, additional aspects, features, and methodologies of the present invention will be readily discernible from the description herein, by those of ordinary skill in the art. Many embodiments and adaptations of the present invention other than those herein described, as well as many variations, modifications, and equivalent arrangements and methodologies, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the present inventions. In addition, some steps may be carried out simultaneously.

The foregoing description of the exemplary embodiments has been presented only for the purposes of illustration and description and is not intended to be exhaustive or to limit the inventions to the precise forms disclosed. Many modifications and variations are possible in light of the above teaching.

The embodiments were chosen and described in order to explain the principles of the inventions and their practical application so as to enable others skilled in the art to utilize the inventions and various embodiments and with various modifications as are suited to the particular use contemplated. Alternative embodiments will become apparent to those skilled in the art to which the present inventions pertain without departing from their spirit and scope.

Accordingly, the scope of the present inventions is defined by the appended claims rather than the foregoing description and the exemplary embodiments described therein.

While certain exemplary aspects and embodiments have been described herein, many alternatives, modifications, and variations will be apparent to those skilled in the art. Accordingly, exemplary aspects and embodiments set forth herein are intended to be illustrative, not limiting. Various modifications may be made without departing from the spirit and scope of the disclosure.

What is claimed is:

1. An automobile diagnostic controller in serial communication with a vehicle, the controller comprising:
a housing, the housing including:
a plurality of OBD-II compliant pins, the pins forming a connection with an OBD-II port, the OBD-II port in communication with an on-board vehicle processor;
a wireless receiver, the wireless receiver configured to receive, from the on-board vehicle processor:
a unique telephonic numeric identification number associated with the controller;
an IMEI identification number;
an Internet Protocol address; and
an initial command sequence via an SMS protocol;
a wireless transmitter configured to transmit, to the on-board vehicle processor, instructions to initiate the sequence protocols for the controller, including:
assigning an Access Point Name (APN) gateway identifying the Packet Data Network (PDN);
assigning a port channel between the controller and the on-board vehicle processor;
assigning a unique SMS identifier number to the controller;
assigning a communication protocol for communication between the controller and the on-board vehicle processor;
vehicle diagnostic pin-readouts, the pin-readouts including GPS coordinates; and
the controller further configured to:
receive a query, via the receiver; and
transmit, via the transmitter, a query response command, the query response command including data packet transmission of a geofence coordinate activation sequence, the geofence coordinate activation sequence including data packet transmission of a first series of geolocation coordinates from a GPS antenna, data packet transmission of a second series of geolocation coordinates from a GPS antenna, and a tagged sequence initiation for associating vehicular location with geofence coordinate disruption, based on the first series and the second series including coordinate data packet disruptions.

2. The controller of claim 1 wherein the query response command is transmitted in response to a data packet transmission receipt that the vehicle has violated the geofence.

3. The controller of claim 1 wherein, upon initiation of the device activation sequence, the apparatus transmits, via the wireless transmitter, an operational input data packet transmission to a second processing device.

4. The controller of claim 1 wherein the receiver is further configured to receive, via the assigned communication protocol, a location query for a current location of the vehicle.

5. The controller of claim 4 wherein, in response to the location query, the transmitter transmits the location of the vehicle.

6. The controller of claim 5 wherein the geofence is formed using a mileage radius, the processor further configured to convert the mileage radius into GPS coordinates.

7. The controller of claim 4 wherein the location query comprises the steps of:
querying the GPS location of the vehicle;
determining the GPS location of the vehicle from the GPS antenna located within the controller; and
transmitting the GPS coordinates to a server.

8. An automobile apparatus in serial communication with a vehicle, the apparatus comprising:
a housing, the housing including:
a plurality of OBD-II compliant pins, the pins forming a connection with an OBD-II port, the OBD-II port in communication with an on-board vehicle processor;
a wireless transmitter;
a wireless receiver, the wireless receiver configured to receive, from the on-board vehicle processor, vehicle diagnostic pin-readouts, the pin-readouts including GPS coordinates, the wireless receiver further configured to receive geofence coordinate information corresponding to a geographical area;
a processor coupled to the connector and the wireless receiver, the processor configured to:
determine a plurality of vehicle location coordinates from the GPS;
determine whether a plurality of the location coordinates are located outside the geofence; and
initiate a device activation sequence;
wherein, upon initiation of the device activation sequence, the apparatus transmits, via the wireless transmitter, an operational input data packet transmission to a second processing device.
